(19) United States
(12) Patent Application Publication
(10) Pub. No.: US 2026/0311237 A1
(43) Pub. Date: Oct. 8, 2026

(54) AI PERSONAL FRAGRANCE CONSULTATION AND FRAGRANCE SELECTION/RECOMMENDATION

(71) Applicant: Coty Inc., New York, NY (US)

(72) Inventors: Shanna Weinblatt, New York, NY (US); Yoann LeTensorer, New York, NY (US); Sophie Raviot-Derrien, New York, NY (US); Mariano Agustin Rodriguez-Fraticelli, New York, NY (US); David Joyal, New York, NY (US); Michael John Baker, New York, NY (US)

(21) Appl. No.: 19/133,517

(22) PCT Filed: Feb. 15, 2023
(86) PCT No.: PCT/US2023/062654

§ 371 Date: May 28, 2025

Related U.S. Application Data
(60) Provisional application No. 63/385,088, filed on Nov. 28, 2022.

(51) Int. Cl. G06Q 30/0601; G06Q 30/0201

(52) U.S. Cl. CPC G06Q 30/0631; G06Q 30/0201

(57) ABSTRACT

Data is collected related to a plurality of individuals, and which is used to identify whether any of the data are probable predictors of the individuals' preference for one or more fragrances. The data collection may include passive means and may be collected and/or analyzed in real time. These predictors are then used to provide recommendations of one or more fragrances to one or more individuals on demand or based on real time data.

### CLAIM OF PRIORITY

This patent application claims the benefit of priority to U.S. application Ser. No. 63/385,088, filed Nov. 28, 2022, which is incorporated by reference herein in its entirety.

### FIELD OF THE DISCLOSURE

The present disclosure is generally related to fragrances, particularly the recommendation of one or more fragrances.

### BACKGROUND

How scents are perceived and associated is highly subjective and varies widely between individuals. This makes it uniquely difficult to recommend a fragrance for products such as perfumes or where scents are added.

Further complicating the subjective nature of fragrance preference is that it may also be affected by the mental or emotional state of each individual in addition to their own memories and experiences. Scent has long been established as having a strong associative link to memories.

Product recommendations are typically generalized, such as targeting a market demographic based on aggregate sales data or require a user to provide information based upon which the recommendation is made. What is desired is a method of passively collecting the information necessary to make a fragrance recommendation and to facilitate the recommendation of fragrances using real time data.

The difficulty of matching fragrances to an individual's preferences makes marketing products where fragrances are used difficult. Recommending fragrances can be difficult based upon an individual's stated preferences, particularly when discovery of new fragrances is desired, therefore methods of obtaining additional data, especially via passive means or via dynamic sources of information, is desirable. The ability to match fragrances to user preferences can aid in creating new or personalized formulations of fragrances, marketing of scented products, and may also prove useful in some therapeutic applications. Real time data may be used to make recommendations which may facilitate more frequent use of fragrances, allowing an individual to choose a fragrance for events and circumstances which may be planned for in advance or arise throughout the day, or to help improve their mood.

### DESCRIPTIONS OF THE DRAWINGS

FIG. 1: Illustrates a fragrance recommendation, according to an embodiment.

FIG. 2: Illustrates a fragrance database, according to an embodiment.

FIG. 3: Illustrates a customer database, according to an embodiment.

FIG. 4: Illustrates an event database, according to an embodiment.

FIG. 5: Illustrates an association database, according to an embodiment.

FIG. 6: Illustrates a base module, according to an embodiment.

FIG. 7: Illustrates a data collection module, according to an embodiment.

FIG. 8: Illustrates an analysis module, according to an embodiment.

FIG. 9: Illustrates a parameter selection module, according to an embodiment.

FIG. 10: Illustrates a real time data module, according to an embodiment.

FIG. 11: Illustrates a recommendation module, according to an embodiment.

FIG. 12: Illustrates a fragrance selection module, according to an embodiment.

FIG. 13: Illustrates a feedback module, according to an embodiment.

FIG. 14 is a flow diagram of an example of a method for a fragrance recommendation, according to an embodiment.

FIG. 15 is a block diagram illustrating an example of a machine upon which one or more embodiments may be implemented.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

This is a system for making a fragrance recommendation. This system comprises an electronic device 102 is a computing device which and which may comprise any of a mobile device, phone, tablet, laptop computer, desktop computer, kiosk, etc. The electronic device 102 may comprise a general-purpose computational device or a purpose built, proprietary computational device such as a kiosk or terminal which may be present in a retail location.

The electronic device 102 may comprise at least one of sensors 104, a camera 106, a microphone 108, or an input device 110. The electronic device 102 may be configured to receive direct input from a customer, such as personal information and fragrance preferences via an input device 110 or may alternatively collect data from a plurality of sources passively. The electronic device 102 may comprise a communication interface 112 configured to communicate with the internet or a cloud 114. The communication interface 112 may be connected to one or more electronic devices 102 such as wearable mobile devices including smart watches or wearable sensors 104. The communication interface 112 may also be connected to one or more cameras 106 or microphones 108. For the purpose of this invention, any such sensors 104, cameras 106, microphones 108 or input devices 110 which may be connected to the electronic device 102 via a communication interface 112 will be referred to as a component of the electronic device 102, however any such component may alternatively be one or more separate remote devices connected to the electronic device 102 via a communication interface. A sensor 104 is a detection or measurement device configured to collect data. Sensors 104 typically measure and quantify analog inputs and convert them to digital data though some may natively collect and monitor digital data. Sensors 104 may be any of position sensors (accelerometers, global positioning system, etc.), pressure sensors (manometers, barometers, etc.), temperature sensors (bolometers, thermocouples, thermometers, etc.), force sensors (force transducers), vibration sensors, piezo sensors, fluid property sensors, humidity sensors, strain gauges, photo optic sensors, flow switches, level switches and may further require contact with the item, substance, or material they are measuring or may not require contact. Similarly, some sensors may measure rotary movement, versus linear movement. Non-contacting sensors may additionally comprise hall effect sensors, capacitive sensors, eddy current sensors, ultrasonic sensors, laser sensors or proximity sensors. Sensors 104 may additionally comprise consumable or catalytic chemical reactions including assays. For example, chemical assays may include assessing the longevity of a fragrance based on chemical composition, characteristics of a fragrance based on chemical composition, Additional embodiments may include biometric monitoring sensors such as a pulse oximeter, galvanic skin response sensor, blood pressure, electrocardiogram (EKG), etc. Sensors 104 may be embedded in one or more wearable devices such as smart watches, smart rings, clothing, shoes, etc. or may alternatively be affixed directly to the skin of a customer, such as via an adhesive patch. Data may be collected from one or more sensors 104 on demand or in real time. In some embodiments, the sensor 104 data is collected continuously without interaction from a customer, for example in a home or retail environment. Sensors 104 may additionally be capable of detecting fragrances present in the air such as by sampling the air and identifying one or more volatile compounds based upon their chemical structures or elemental composition, such as via mass spectrometry. A camera 106 is an imaging sensor or array of imaging sensors which take measurements, typically of reflected light, which are then used to recreate and image from the measurements on a display. Each measurement is used to populate values to a pixel or subpixel. Multiple subpixels may create a complete pixel and an array of pixels creates an image. In some embodiments, a plurality of sensor measurements may be used to populate a single pixel or subpixel. The plurality of sensor measurements may be taken from one imaging sensor over a period of time or from multiple imaging sensors taken simultaneously or also over a period of time. The multiple measurements may be averaged together or subjected to a smoothing algorithm to determine a pixel or subpixel values. Each pixel or subpixel value may be determined independently or may be determined via image processing of a part or the whole image, comprised of a plurality of measurements in an array to which one or more algorithms may be applied such as smoothing, edge detection, etc. A camera 106 may be utilized to obtain a video, including live or prerecorded video. A camera may be a standalone device in possession of the customer, integrated into a device worn by the customer, or alternatively be one or more devices directed toward the customer. In some embodiments, the camera 106 may be a third-party device, such as security camera footage, or a camera 106 in a device in the possession of an unrelated party. In such embodiments, facial recognition and location tracking may be utilized to identify a customer. Further examples of cameras 106 may comprise cameras 106 integrated into smart home devices such as a Google Home, Alexa enabled device, Ring doorbell with camera, etc. Likewise, one or more cameras 106 may be integrated into a kiosk or may otherwise be present in a retail environment. A microphone 108 is an audio input device which detects sound waves and converts the analog signal into digital data. The microphone 108 may be integrated into an electronic device 102, a wearable device, or be a standalone microphone interfaced with an electronic device wirelessly or via a cable. Examples of a microphone include condenser microphones, dynamic microphones, electret microphones, etc. The microphone 108 may comprise a single audio pickup capsule or may comprise a plurality of audio pickup capsules. A microphone may be integrated into an electronic device 102 or connected via a cable or wirelessly via a communication interface 112. Data from a microphone 108 may be acquired only when a customer is directly interacting with an electronic device 102 or may constantly be active, collecting data continually in a passive manner. In some embodiments, a microphone 108 may be integrated in a smart home device, such as a Google Home or Alexa enabled device. An input device 110 is any device for capturing input from a user such as a keyboard, keypad, mouse, remote control, joystick, or any other array of switches, dials, etc. arranged to receive input from a user. An input device 110 may additionally be configured to capture gestures such as via a wearable device worn by the user or an image capture system for capturing and analyzing images and/or video to detect gestures made by a user. An input device 110 may additionally comprise a touch screen interface, such as a capacitive, resistive, or pressure detecting surface which may or may not be overlayed upon or beneath a screen capable of displaying content to a user. An input device 110 may also comprise a stylus. An input device 110 may be configured to receive direct customer input such as personal information including demographics, preferences, etc. an input device 110 is generally used in conjunction with an electronic device 102 such as a mobile device, desktop computer, kiosk in a retail environment, etc. Data collected by an input device 110 may be stored in a customer database 118 and may be used as customer characteristics to train a recommendation model for recommending fragrances. A communication interface 112 provides a connection between one or more electronic devices 102 or components. A communication interface 112 may have a physical interface to accept a cable connector such as an ethernet cable, optical cable, USB cable, etc. or may provide for a wireless connection. To provide a wireless connection, a communication interface 112 will include an antenna to send and/or receive data via electromagnetic waves. Wireless connections may be established using any communication protocol such as Wi-Fi, Bluetooth, infrared (IR), cellular (3G, 4G, 5G, LTE, etc.), near field communication (NFC), radio frequency identification (RFID), global positioning system (GPS), etc. In some embodiments, a communication interface 112 may utilize light to establish a physical connection, such as using fiberoptic cables or wirelessly via one or more lasers, visible light communication, etc. A cloud 114 is a network of distributed computational and data storage resources. A cloud 114 may be a public cloud, such as accessible via the internet, or may be a private cloud, which may be isolated from access via the internet. Similarly, a cloud 114 may be widely accessible or access may be restricted via encryption, authentication, etc. In some embodiments, a cloud 114 may be maintained by a third party, where resources are provisioned for one or more users and/or organizations. A fragrance database 116 stores data related to the name, descriptions, characteristics, ingredients, and chemical makeup of a plurality of fragrances or compounds for adding scents and/or flavors to products such as perfumes, colognes, candles, air fresheners, shampoo, bodywash, deodorants, personal care products, detergents, etc. The data may additionally include manufacturer and information related to the manufacture of the fragrances. The data may be populated by one or more manufacturers, vendors, such as via a connected third-party database via the cloud 114. The customer database 118 stores data about one or more customers. The data may comprise characteristics which describe the user universally, such as applicable at all times, or conditionally, such as only applicable sometimes under certain conditions. Universal characteristics may comprise a customer's personality, genetic information, allergies, customers' stated preferences unless indicated as conditional, etc. For example, a genetic sample (e.g., DNA, etc.), a genetic profile, or other genetic information may be obtained from a user upon consent. The genetic information may be evaluated to identify genetic markers indicative of an allergy, pheromone preference, scent preferences, etc. The resultant genetic profile may be used to prevent presentation of fragrances that may be a potential allergen for the user or that the user may be genetically predisposed to dislike. The genetic information may be used in conjunction with chemical assays to determine chemical compositions of fragrances that can be matched with the genetic profile of the user. This may include observing decomposition of a fragrance to determine additional chemicals or chemical reactions present through the life of the fragrance after application. The Conditional characteristics may comprise a customer's mood, an occasion, location or environment, etc. The customer database 118 is populated by the data collection module 126 and the feedback module 138 and may additionally be populated by one or more proprietary or third-party database and one or more application programming interfaces (APIs). Examples of third-party data may include social media activity feeds from services such as Facebook, Twitter, TikTok, etc., as well as music and video streaming platforms such as Spotify and dating apps and sites such as Tinder. In some embodiments, customer data may be stored in accordance with a privacy and/or customer data retention policy and/or in compliance with regulations such as the General Data Protection Regulation (GDPR). The event database 120 stores data relating to one or more events, occasions, trigger conditions, etc. The data stored in the event database 120 may comprise historical data, such as events which have occurred in the past, such as a log of trigger conditions, one or more tables of trigger conditions, which when detected, initiate an action, such as a recommendation module 134. In some embodiments, the action initiated by a detected trigger condition may be an analysis module 130 and/or a parameter selection module 132. The event database 120 may additionally store and or access data related to one or more customers' schedules or calendars. Schedules or calendars may be available through the customer's personal computing devices and operating system (such as a computer or mobile phone) or may be available through social media sources such as Facebook. The event database 120 may additionally store data relating to interactions of a customer with other individuals, objects, etc. which may comprise trigger conditions. The association database 122 stores data relating to the relationship between one or more customer characteristics and one or more fragrances. The association data being indicative of the one or more customer characteristics likelihood of predicting one or more customers' preferences for one or more fragrances. The association database 122 is populated by the analysis module 128 and is used by the parameter selection module 130 and the recommendation module 134. The base module 124 initiates the data collection module 126 which collects data from at least one data source including any of a sensor, camera, microphone, input device, third party database, proprietary database, survey, etc. and saves the collected data to the customer database 118. The base module 124 receives the collected data from the data collection module 126 and initiates the analysis module 128. The analysis module 128 uses the collected data and data stored in the customer database 118 and the fragrance database 116 to identify one or more associations, or pairing of customer characteristics and fragrances, which are saved to the association database 122. The base module 124 receives the associations from the analysis module 128 and initiates the parameter selection module 130. The parameter selection module 130 evaluates each association to determine whether the associations are strong predictors of a preference for one or more fragrances and the parameter selections are saved to the association database 118. The base module 124 receives the selected parameters from the parameter selection module 130 and initiates the recommendation module 134 which creates and/or trains a recommendation model which is used to generate one or more fragrance recommendations. The base module 124 receives the one or more fragrance recommendations from the recommendation module 134 and initiates the fragrance selection module 136. The fragrance selection module selects one or more fragrances from the recommended fragrances identified by the recommendation module 134. The base module 124 receives the selected fragrance(s) from the fragrance selection module 136 and initiates the feedback module 138. The feedback module 138 receives feedback from one or more customers and saves the feedback to the customer database 118. The base module 124 receives the customer feedback from the feedback module 138 and ends the recommendation process. The data collection module 126 collects data from at least one source comprising any input device 110, such as cameras, sensors, third party or proprietary databases, etc. The data collection module 126 initializes the input devices 110 and receives data from the devices which is then saved to the customer database 118. The analysis module 128 receives data from the customer database 118 and the fragrance database 116. The analysis module 128 selects customer characteristic data from the customer database 118 and fragrance data from the fragrance database 116 and identifies associations for pairings of customer characteristics and fragrance. In some embodiments, the associations are quantifiable, whereas in other embodiments, the associations are subjective or may be made by a human screener. The associations are saved to the Association database 122 and the process is completed for all combinations of customer characteristics and fragrances. The parameter selection module 130 receives data from the fragrance database 116 and the association database 122 and the association data is assessed for the ability to predict a preference for each fragrance, such as by comparing a quantified correlation coefficient to a threshold value and selecting the correlation as a parameter. Alternatively, the associations with the highest correlation coefficients may be selected as parameters. The parameters will be used to create a recommendation model which will be used to select one or more fragrances to recommend to one or more customers. The real time data module 132 polls data continuously, or on regular short intervals, which may range in time from seconds, minutes, hours or days, from one or more sensors 104, cameras 106, microphones 108, or input devices 110 and checks for a trigger condition. A trigger condition may be a specific sensor 104 measurement or set of measurements, one or more inputs from an input device 110, or a specific pattern, object, location, sound, person, etc. via at least one camera 106 and/or microphone 108 or a combination of patterns, objects, sounds, etc. Alternatively, a timeout may be used to end monitoring by the real time data module 132 after a specified amount of time has elapsed, regardless of whether a trigger condition has been detected. When a trigger condition has been detected, the real time data module 132 saves the trigger data to the event database 120 and returns the trigger data to the base module 124. The recommendation module 134 receives the selected parameters determined by the parameter selection module 130, and data from the customer database 118, to train a recommendation model. In an embodiment, the recommendation model may be a machine learning model. In alternate embodiments, the recommendation model may comprise a lookup table, decision tree, etc. The recommendation model is then used to generate recommendations from the plurality of available fragrances stored in the fragrance database 116, which may comprise a preference score representing the customer's probability of responding positively to a fragrance. The recommendations may comprise a set or combination of fragrances, a class of fragrances, etc. The fragrance selection module 136 receives a plurality of recommendations generated by the recommendation module 134 and additionally data from the fragrance database 116 and the customer database 118 which is used to select one or more fragrances. Additionally, customer characteristics, preferences, or other weightings may be considered when selecting one or more fragrances. The feedback module 138 receives the selected fragrances and sends a feedback request to the customer. The feedback request may be included with a sample of the recommended fragrances. Alternatively, the feedback request may comprise a digital survey request. The feedback module 138 further receives feedback from one or more customers which may comprise the completion of a survey or may comprise behavioral cues such as purchasing products containing one or more of the recommended fragrances, returning a product containing a fragrance, recommending a fragrance or product containing a fragrance to a social connection, or facial analysis of the customer's reaction when using or encountering a fragrance or a product containing a fragrance. In an example, one or more fragrances may be recommended based upon the recognition and identification of an emotional state of the user. An emotional state may be identified based upon facial expressions, gestures, tone of voice, message context, biometric information such as heart rate and blood pressure, galvanic skin response, etc.

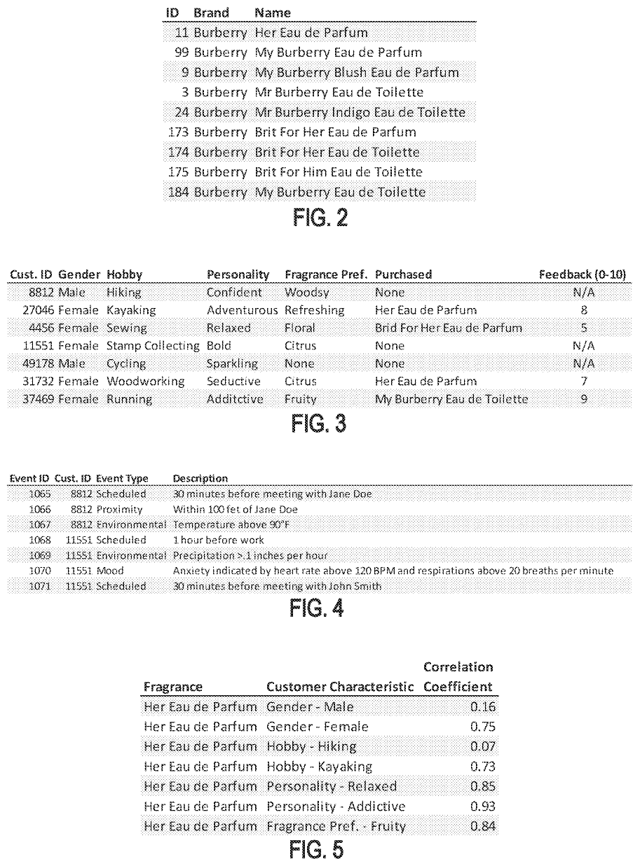

Functioning of the “Fragrance Database” will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the fragrance database 116. The fragrance database 116 stores data related to one or more fragrances. The data at least comprising a fragrance name and a unique identifier or ID. The fragrance database 116 may additionally comprise descriptions, characteristics, ingredients, and the chemical makeup of a plurality of fragrances or compounds for adding scents and/or flavors to products such as perfumes, colognes, candles, air fresheners, shampoo, bodywash, deodorants, personal care products, detergents, etc. The data may additionally include information about the manufacturer, brand, and vendor information and information related to the manufacture of the fragrances including manufacturing process steps. The data in the fragrance database 116 may be populated by one or more fragrance manufacturers, vendors, etc., and is utilized by the analysis module 128, the parameter selection module 130, the recommendation module 134, and the fragrance selection module 136.

Functioning of the “Customer Database” will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the customer database 118. The customer database 118 stores data about one or more customers. The data may comprise identifiable information, such as name, phone number, email address, home address, etc., and may comprise characteristics which describe the user. Customer data, in particular personal identifiable information, shall be stored in compliance with privacy and customer data retention policies in addition to regulations such as the General Data Protection Regulation (GDPR). Such policies and regulations may require consent from customers prior to data being captured, stored, or transmitted to a server for analysis. In some embodiments, data may be collected and stored locally on a customer's private device without obtaining permission, however such permission may still be required prior to analysis of the obtained data. Obtained data analyzed using a private device, including but not limited to the results of the analysis, may not be transmitted external to the device without receiving consent from the customer. In some embodiments, consent may be implied, such that the user is presented with a message that continuing to use the device and/or program is considered consent to use their personal information, whereas in other embodiments consent is explicit, requiring the customer to make a selection confirming, or denying consent. Examples of characteristics may include gender, hobbies, personality traits, fragrance preferences, items purchased, feedback related to purchased products, etc. Data may additionally include information such as genetic information, allergies, non-fragrance preferences, mood, personality, reactions to stimuli, occasions of interest, locations, environments, etc. Customer characteristics may additionally be conditional on the presence of other customers, social media contacts associated with the customer, places, etc. such that the user's preference or selection of a fragrance may be influenced by the other customer, the location, etc. Customer characteristics may also include innate information about the customer such as part or all of their genome, genetic code, physical features, etc. Some customer characteristics such as personality, mood, reactions, etc. may be determined based upon analysis of other customer characteristics such as facial features, tone of voice, etc. In an example, personality of a user may be analyzed based upon preferences and measurable metrics to identify a personality type and/or personality characteristics. The personality characteristic data may then be used to recommend one or more fragrances to the user. These features may be used as customer characteristics directly and/or may be used to derive an intermediary customer characteristic such as personality, mood, reactions, etc. The customer database 118 is populated by the data collection module 126 and the feedback module 138 and may additionally be populated by one or more proprietary or third-party databases and/or application programming interfaces (APIs).

Examples of connected third-party data sources may include social media networks, vendor websites, search engine, web tracking and advertisement services, etc. The customer database 118 is utilized by the analysis module 128, the recommendation module 128, and the fragrance selection module 136. In some embodiments, the customer database 118 may additionally be utilized by the feedback module 138 to determine where to send feedback requests such as customer satisfaction surveys and additional promotions. In an example, one or more samples may be selected to send to a user based upon a plurality of parameters determined from data collected regarding the user. The data may be provided by the user, collected from passively monitoring the user, etc. The samples are then selected from a database and sent to the user for assessment. The user may additionally provide feedback based upon their experience and reactions to the provided samples. Additional fragrances may be recommended based upon feedback received from the user. In an example, multiple fragrances may be selected with the intent to send the customer a plurality of fragrances instead of a single fragrance. As part of the recommendation, one or more fragrances may be automatically provided to a customer, such as part of a sample to allow the customer to assess the one or more fragrances. In an example, the customer may be provided with an opportunity to purchase the one or more fragrances. In an example, the one or more fragrances may be purchased as a gift. In an example, the one or more fragrances may be presented as a notification to the user such as via an email, SMS message, application notification, etc. Said notification or opportunity to purchase may additionally comprise an incentive to buy, such as a discount, rebate, money back guarantee, etc. In a preferred embodiment, the one or more fragrances are selected and provided based upon parameters and/or recommendations customized based upon the customer's available customer characteristics.

Functioning of the “Event Database” will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the event database 120. The event database 120 stores data relating to one or more events, occasions, trigger conditions, etc. The data stored in the event database 120 may comprise historical data, such as events which have occurred in the past, such as a log of trigger conditions, one or more tables of trigger conditions, which when detected, initiate an action, such as a recommendation module 134. In some embodiments, the action initiated by a detected trigger condition may be an analysis module 130 and/or a parameter selection module 132. The event database 120 may additionally store and or access data related to one or more customers' schedules or calendars including those provided by third parties. The event database 120 may additionally communicate with social media services to access events including when and where they will occur. The event database 120 may additionally store data relating to interactions of a customer with other individuals, objects, etc. which may comprise trigger conditions. The event database 120 is populated by the data collection module 126, real time data module 132, analysis module 130, and parameter selection module 132 and may additionally be populated by the feedback module 138. The event database is used by the real time data module 132, analysis module 130 and parameter selection module 132 and may additionally be used by the fragrance selection module 136.

Functioning of the “Association Database” will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the association database 122. The association database 122 stores data relating to the relationship between one or more customer characteristics and one or more fragrances. The association data indicates the degree to which the one or more customer characteristics are associated with the one or more fragrances such as indicated by a correlation coefficient. Other descriptors of an association may be descriptive rather than quantitative, such as high, medium, or low. Other examples may include unlikely, somewhat unlikely, indifferent, somewhat likely, or likely to have a predictive association such that the customer characteristics may indicate or be used to predict a preference for one or more fragrance. Associations may additionally comprise information which is indirectly relevant to a customer's characteristics, preferences, etc. such as the fragrance preferences of one or more additional customers in proximity to the first customer. For example, a first customer's fragrance preference or selection may be impacted by the preferences of other customers in proximity to them. The other customer's may not be current or prospective customers despite being described or referred to as customers. The association database 122 is generated by the analysis module 128 and is used by the parameter selection module 130.

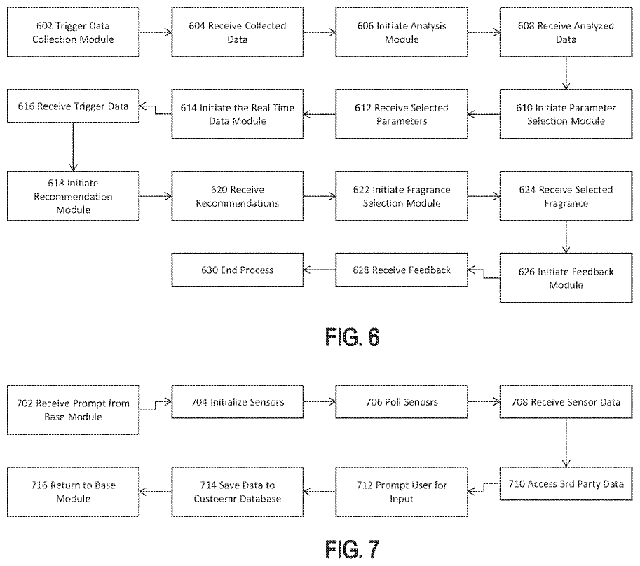

Functioning of the “Base Module” will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the base module 124. The process begins with initiating, at step 602, the data collection module 126. The data collection module 126 initializing sensors 104, cameras 106, microphones 108 and other input devices 110 and polling the initialized devices for data. The data collection module 126 additionally accessing third party data, such as from social media, and prompting the user to provide direct input via at least an input device 110. The data is saved to the customer database 118. Receiving, at step 604, the collected data from the data collection module 126. The data may be collected from any of one or more sensors 104, cameras 106, microphones 108, input devices 110, or third-party sources such as private or proprietary databases owned and maintained by social media companies. Initiating, at step 606, the analysis module 128. The analysis module 128 querying the customer database 118 and the fragrance database 116 and selecting a first fragrance and a first customer characteristic. Calculating correlations and/or identifying associations between the first fragrance and the first customer characteristic and saving the calculated correlations and/or identified associations to the association database 122. Further determining whether there are more customers and selecting a second customer characteristic if there are more customer characteristics available to analyze, otherwise determining whether there are more fragrances available. If there are more fragrances available, selecting a second fragrance to analyze. Receiving, at step 608, the analyzed data from the analysis module 128 comprising correlations and/or identified associations when all customer characteristic and fragrance combinations have been analyzed. The resulting data may be quantitative, such as correlation coefficients representing the likelihood of one or more customer characteristics being predictors for a preference for one or more fragrances or may be more generalized associations between customer characteristics and fragrances. Initiating, at step 610, the parameter selection module 130. The parameter selection module 130 querying the fragrance database 116 and the association database 122 and selecting a first fragrance and a first association such as by comparing a correlation coefficient with a threshold value. Alternatively, an association may be identified between a customer characteristic and a fragrance via methods which do not rely on statistical principals including subjective assessments. Associations may be evaluated for the strength of the association and may additionally consider the context of the association, such that the combination of multiple associations may increase the predictive relevance of the association. A correlation or association is selected as a parameter if the correlation coefficient is above a threshold value, or the association is found to be a sufficient predictor of a fragrance preference. If there are more associations, a second association is selected, otherwise if there are more fragrances, a second fragrance is selected. Receiving, at step 612, the selected parameters from the parameter selection module 130. The selected parameters comprising correlations and/or associations which represent pairings of customer characteristics and fragrances which have a high likelihood of accurately predicting a customer's preference for one or more fragrances. Initiating, at step 614, the real time data module 132. The real time data module 132 receiving the selected parameters from the base module 124 and querying the event database 120 for one or more trigger conditions. The real time data module 132 polls one or more sensors 104, cameras 106, microphones 108, input devices 110, and external data sources for additional data in real time (or on regular intervals) and determines whether a trigger condition is detected among the one or more streams of data. Optionally, the real time data module 132 may check whether a timeout value, such as a predefined amount of time, has passed without identifying a trigger condition amongst the received real time data, and returning to the base module 124 if the timeout value is reached, otherwise continuing to poll sensors 104 and access external data. If a trigger condition is identified, saving the trigger data to the events database 120 and returning the trigger data to the base module 124. Receiving, at step 616, trigger data from the real time data module 132. The trigger data comprising at least one trigger condition, which may be an event, occasion, detected object, person, scent, environmental attribute, etc. which may represent a change in at least one customer characteristic which may result in a new fragrance recommendation. For example, receiving a trigger condition comprising detection of a customer's planned attendance of an upcoming music event based on a Facebook calendar update. Initiating, at step 618, the recommendation module 134. The recommendation module 134 querying the customer database 118 and the fragrance database 116 for data related to the selected parameters and using the data, comprising related customer characteristics and fragrances to train a recommendation model. The recommendation module 134 may additionally receive trigger data. In some embodiments, the recommendation model may be a lookup table or a decision tree. The recommendation model being further used to generate one or more fragrance recommendations. Receiving, at step 620, one or more fragrance recommendations from the recommendation module 134. The recommendations may comprise one or more fragrances, fragrance families, or groups of fragrances sharing common characteristics. Initiating, at step 622, the fragrance selection module 136. The fragrance selection module 136 querying the fragrance database 116 and the customer database 118 for recommended fragrance data and additional customer data such as customer input and feedback and selecting one or more fragrances from the recommended fragrances. Receiving, at step 624, one or more selected fragrances from the fragrance selection module 136. Initiating, at step 626, the feedback module 138. The feedback module 138 receiving one or more selected fragrances and optionally requesting feedback from one or more customers. Receiving customer feedback via direct or indirect methods, such as by providing surveys or monitoring sales activity and saving the customer feedback to the customer database 118. Receiving, at step 628, customer feedback from the feedback module 138. The customer feedback comprising data which explicitly or implicitly indicates one or more preferences for one or more fragrances. Ending, at step 630, the fragrance recommendation process.

Functioning of the “Data Collection Module” will now be explained with reference to FIG. 7. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the data collection module 126. The process begins with receiving, at step 702, a prompt from the base module 124 to begin data collection. The prompt may be automated or a manual action to begin collecting data from one or more customers. The data collection may be prompted by customer actions, such as registration at a website, purchase of a product containing a fragrance, etc. Initializing, at step 704, one or more sensors 104, to be used in data collection. Initializing including the powering on of the sensor 104 devices and may additionally comprise a handshake, where a signal is sent to the sensors 104 and a response is received to confirm that the sensor 104 has powered on and is ready to collect data. Sensors may additionally refer to cameras 106, microphones 108, or any other input device 110. In an embodiment, establishing a connection with the sensors 104 in a mobile phone including the phone's accelerometer, microphone(s), camera(s), etc. Polling, at step 706, the one or more sensors 104, cameras 106, microphones 108, input devices 110, etc. for data input. In an embodiment, an accelerometer may collect position and movement data from a customer. In a further embodiment, a microphone 108 may collect audio data containing the customer's voice which may later be analyzed to determine the customer's sentiment. Similarly, camera 106 data may be collected. Further embodiments may collect data from sensors 104 configured to detect and analyze the composition of volatile compounds to determine the scents present when collecting data about the customer. Similarly, the position data may be used to determine where in a store the customer is positioned and determine which scented products or fragrance samples the customer may be near while collecting data which can be used to measure the customer's reactions. In an embodiment, at least one camera 106 oriented towards a customer captures at least one image of the customer while the customer is presented with at least one fragrance such that the at least one image comprises a facial expression reacting to the at least one fragrance. In other embodiments, a fragrance is not present, however the customer may be prompted to make an expression following an instruction which is captured by the at least one camera 106. Such image data may later be used to identify a reaction, mood, or personality which may be evaluated as a potential predictor of a fragrance preference. In another embodiment, camera 106 captures image data of a customer in order to conduct facial feature analysis, such as shape, features and spacing, etc. that may be related to a set of personality characteristics and further used as a potential predictor of a fragrance preference. Similarly, one or more microphones 108 may be used to collect audio samples of the customer's voice upon which the audio can be processed, and the tone of the customer's voice analyzed for indications of reaction, mood, or personality which may be evaluated as a potential predictor of a fragrance preference. In another embodiment, the customer may provide passive data via a wearable device that contains at least one sensor 104, which may provide real time data continuously or on regular intervals. The customer may also submit data via one or more input devices 110 such as by following prompts and answering questions on a touch screen or entering data via a keyboard and/or mouse. In some embodiments, the data collected may additionally comprise data relating to one or more customers or individuals within proximity of the customer. For example, a customer may be in proximity of another individual, and data may be collected pertaining to both the customer and the other individual. This may require a previous association, such as sharing contact information between electronic device 102 carried by both individuals, or the individuals being friends or contacts on one or more social media platforms such as Facebook. Receiving, at step 708, sensor 104 data from the sensors 104. The sensor 104 data may be temporarily stored in the sensor 104 devices and transmitted to an electronic device 102 in batches or packets or may be streamed continuously. The method of data transfer may be dependent on network connectivity at the time of data collection such that data is stored on the local sensor 104 device while there is a poor or no network connection to the electronic device 102, internet, or cloud 114, and is then transmitted when the network connection is available. Likewise, when the network connection is available, the data may be streamed in real time. In an embodiment, the electronic device 102 having a reliable connection with at least one sensor 104, such as an accelerometer, and receiving data in real time. In an embodiment, image data is received in real time from at least one camera 106 oriented towards the customer's face, capturing facial expressions. A microphone 108 may additionally be used to collect the customer's voice. In some embodiments, sensors 104 may be used to detect the volatile compounds in a fragrance which may allow the fragrance to be determined. Accessing, at step 710, third party data from one or more third party data sources. Third party data may comprise a connected device comprising a plurality of sensors 104, cameras 106, microphones 108, and input devices 110. Third party data sources may additionally comprise databases owned and managed by a third party such as those managed by social media providers. This data is generally made available via an application programming interface (API) which allows external applications to access information or services. Alternatively, web scraping may be utilized to access similar information. In an embodiment, the data collection module 126 accessing social media data from Facebook and Twitter and determining the friends, followers, and people the customer is following and additionally collecting public posts made by the customer and by the customer's friends, followers, etc. which mention or tag the customer. The social media data may additionally comprise products and services that the customer has liked or otherwise expressed interest in. Social media data may additionally comprise engagement data for one or more customers, such as likes, posts, shares, comments, etc. Posted content may be analyzed for sentiment to determine whether a user's comments are positive or negative, which may relate directly to a fragrance, product containing a fragrance, or may alternatively relate to other data such as interests, hobbies, etc. which may be used independently or which may be used to identify a customer's personality. When real time data is accessed, recent social media data may be utilized to determine a customer's mood, and in some embodiments, may identify indicators of more chronic psychological issues such as anxiety, depression, etc. Social media data may additionally comprise data relating to fragrance preferences of friends or contacts of the customer, particularly where the customer's fragrance preferences or selections are different when in proximity to the friends or contacts of the customer than when the customer is not in proximity to those individuals. Data may additionally be sourced from music or video download and/or streaming services, dating services, etc. Third party data may also comprise sales and returns data from one or more vendors for fragrances as well as clothing, cosmetics, personal care products, etc. Such data may be sourced from a retailer or manufacturer CRM. Third party data may comprise genetic and/or medical data from a genetic testing service provider such as 23andMe, or from a medical care provider. In some embodiments, genetic data may be utilized, such that a genetic sequence may be used as a customer characteristic which may be correlated to one or more fragrances. Similarly, genetic sequences or other medical data may reveal medical information such as allergies, which may allow a recommendation to be made which prevents a fragrance from being recommended which may cause an allergic reaction and which may be used to notify a customer of products which may cause adverse reactions. Accessing sensitive data such as genetic information and/or medical health records may require the customer to provide explicit consent to access such records. Such records may additionally be subjected to additional regulation and security protocols. Third party data may further relate to location, geography, climate, weather, and calendar data, including from public and private calendars. Examples of geography may include data sourced via physical location of a customer, such as a mall, airport, or retail shops through wireless communication (Wi-Fi, Bluetooth beacons etc.) Examples of weather may include weather forecasts for a customer's location which may include temperature, humidity, precipitation, wind, etc. Environmental data, which is generally only related to a customer based upon their location, may be treated similarly to a customer characteristic, such that a person's environment is known to impact at least their mood in some circumstances, and therefore may be used in the same capacity as a conditional customer characteristic. Likewise, environmental data, such as temperature, humidity, etc., may impact how a fragrance is perceived or persists in the environment. In an embodiment, environmental data could be used to determine the longevity of a fragrance and a user may be provided a notification when a fragrance, such as a perfume, should be reapplied. Examples of calendars may comprise personal or work calendars in mobile device apps, a productivity suite, such as Google or Office365, or public or social calendars such as which may be on community web pages, social networks such as Facebook, etc. In an embodiment, connecting to a retailer's database and confirming that a female customer with customer ID 27046 purchased Her Eau de Parfum. Prompting, at step 712, the user, or customer, for input. Prompts for input may comprise a text message, instructions on a kiosk, mobile device screen, website, etc. and the user input may be provided via an input device 110. User input may additionally or alternatively be provided by one or more sensors 104, cameras 106, microphones 108, etc. For example, a prompt may request that the customer read text aloud or dictate their response orally to be received via a microphone. In an alternate embodiment, the user may be provided images or fragrances and their reactions may be captured via one or more cameras 106. Further embodiments may comprise completion of a survey via a keyboard input device 110. A prompt for user input may additionally comprise a live video interaction between the customer and a video recording, or with a live person, or dynamically generated content, or using pre-recorded video feed. In some embodiments, the user input may prompt the customer to provide information about one or more individuals such as friends or contacts of the customer, or other customers for whom the customer may be purchasing a fragrance. This data about individuals other than the customer may be used in situations such as searching for recommendations for a gift or may be used to determine the fragrance preferences of the other individuals so as to identify impacts on the customer's preferences when in proximity to, or expected proximity to, the individuals. For example, the customer may prefer a fragrance which both the customer and another individual or customer prefers when they are in proximity, whereas when not in proximity, the customer may prefer a different fragrance. Saving, at step 714, the data collected by the data collection module 126 to the customer database 118. Returning, at step 716, to the base module 124.

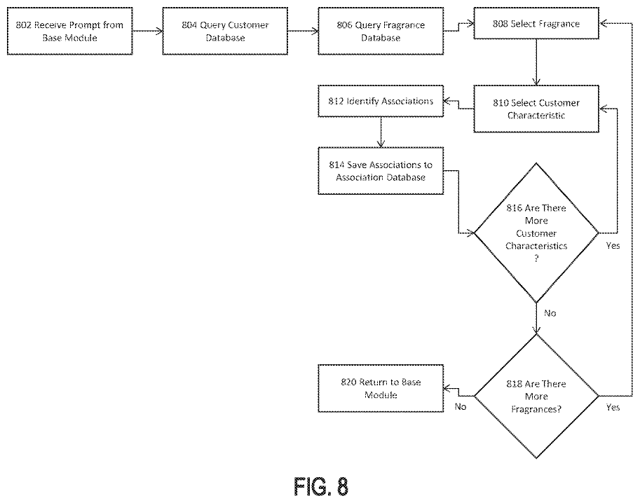

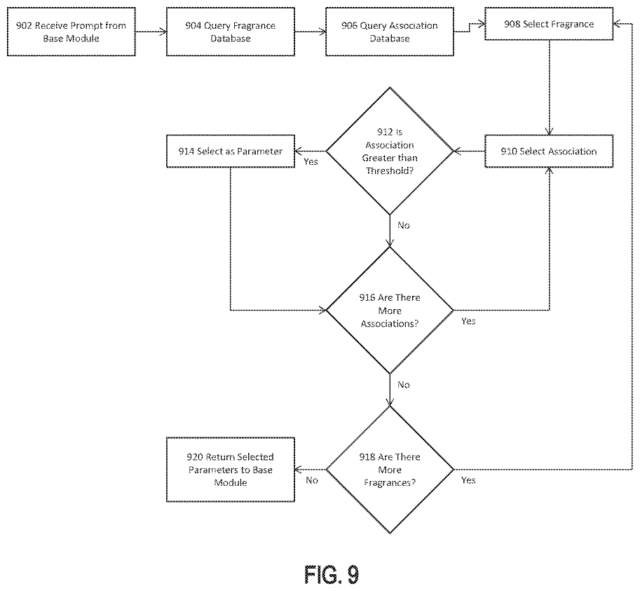

Functioning of the “Analysis Module” will now be explained with reference to FIG. 8. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the analysis module 128. The process begins with receiving, at step 802, a prompt from the base module 124. The prompt may contain customer data collected from the data collection module 126. The prompt may additionally include instructions such as to perform an analysis of all data, only newly collected data, or only data pertaining to a specific customer. Querying, at step 804, the customer database 118 for customer characteristic data from at least one customer. The data may additionally comprise customer feedback data such as a customer's fragrance preferences to include fragrances they liked, fragrances they did not like, and may additionally include quantifiable scoring, such as a customer describing a fragrance with an ID of 11 with a score of 7 out of 10. Examples of customer characteristic data may comprise images of a customer's face including when the customer is reacting to a particular fragrance. The data may comprise voice and or video recordings of the customer responding to prompts. Customer characteristics may additionally comprise hobbies, personality traits, their gender, location, places visited, purchase history, etc. Any data which could be used to describe a customer, their preferences, behaviors, etc. may be used as customer characteristics. The customer data may be aggregate data or may be for a single customer. Querying, at step 806, the fragrance database 116 for one or more fragrances. The fragrance data may include specific fragrances, but may also include their characteristics, ingredients, etc. such that analysis of customer characteristics paired with fragrances may alternatively be between fragrance characteristics and/or ingredients. This allows for more generalized comparisons and recommendations instead of only explicit comparisons. In some embodiments, both explicit and generalized data is used to allow the identification of a family of related or similar fragrances from which a recommendation may be selected for a customer. Selecting, at step 808, a fragrance, fragrance characteristic, or fragrance ingredient from the data retrieved from the fragrance database 116. In an embodiment, selecting the fragrance with ID 11, Her Eau de Parfum. In some embodiments, a fragrance may be selected based upon environmental data, such as volatile compounds in the air which may be components of a fragrance. These volatile compounds may be detected and used to identify a fragrance in proximity to a customer. The detected fragrance may then be analyzed to identify an association between the detected fragrance and one or more customer characteristics, such as images from a camera 106 capturing a customer's reaction to the detected fragrance. Selecting, at step 810, a customer characteristic from the customer data retrieved from the customer database 118. In an embodiment, the customer characteristic is an image of the customer taken when the customer was sampling the fragrance with ID 11. The customer may have instead been sampling a different fragrance than the selected fragrance. The customer characteristic can alternatively be unrelated to fragrances, such as the user's personality, mood, favorite food, favorite activities, etc. In another embodiment, selecting an adventurous personality as a customer characteristic. In some embodiments, customer characteristics may comprise categories or groups of customers which may be characterized by one or more customer characteristics. For example, people with adventurous personalities, or a preference for fruity fragrances, or who like a particular activity such as hiking. Other groupings may relate to demographics, habits, musical preferences, clothing, hair or cosmetic style preferences, preferred reading genres, etc. In some embodiments, customer characteristics may comprise emotions, or a customer's emotional state. The customer's emotional state may be identified based upon facial expressions, gestures, tone of voice, message context or biometric information such as heart rate, blood pressure, galvanic skin response, EKG, etc. The emotional state may be identified using similar methods to personality via one or more algorithms including machine learning. In some embodiments, genetic data may be utilized, such that a genetic sequence may be used as a customer characteristic. Alternatively, medical history data may be utilized, such as allergies, medications, chronic conditions, etc. In other embodiments, social media data may be utilized as customer characteristics. Examples may include a customer's engagement activity such as pages viewed, activities and events responded to, locations where the customer checked in, reviewed, etc., the customer's like's comments, follows, shares, etc. The customer's content, including posts, comments, etc. may additionally be analyzed via context analysis to determine the customer's sentiment, including whether a post or message indicates a positive or negative review, or a recommendation of a fragrance, or a product containing a fragrance, etc. In an embodiment, a Facebook user may share a post of a perfume and may additionally ‘like’ and post a comment which contains positive words indicating a positive sentiment which may be a recommendation or endorsement of the product. In some embodiments, multiple customer characteristics may be selected in combination. Likewise, the same customer characteristic may be included in a plurality of different combinations. Identifying, at step 812, an association between the selected customer characteristic and the selected fragrance. In an embodiment, an association is determined by calculating a correlation coefficient representing the probability of the selected customer characteristic being a predictor of a customer's preference for the selected fragrance. In some embodiments, such as those utilizing machine learning or another automated algorithm, the correlation coefficient may be a quantifiable statistical relationship, such as a Pearson correlation coefficient, by comparing data from a large sampling of customers to determine the dependency of one variable, in this case the selected customer characteristic, on a second variable, in this case the selected fragrance. In alternate embodiments such as those using a decision tree or lookup table, a more generalized association between the selected fragrance and the selected customer characteristic may be identified such as a person with a particular customer characteristic being more likely or less likely to purchase a particular fragrance. In some embodiments, associations may be determined based upon manual or digitally collected interviews to ascertain customer preferences and the creation of association definitions based upon subjective or other analyses of the collected data. In an embodiment, an association may comprise gender such as a customer being female and an associated fragrance Her Eau de Parfum. In another embodiment, identifying that a customer characteristic of a fruity fragrance preferences and associating it with the fragrance, My Burberry Eau de Toilette. In some embodiments, multiple customer characteristics may be considered together, such as females with seductive personalities which may be associated with the fragrance, Her Eau de Parfum. Associations represent potential predictive relationships between one or more customer characteristics and one or more fragrances. Another example of an association may use a customer's genetic sequence, for example to identify allergies to a component of one or more fragrances, or to aggregate customer preferences correlated with one or more genetic sequences. In some embodiments, environmental data may be used as a customer characteristic, for example, as a factor which may impact a customer's mood. Likewise, increased temperature may increase the volatility of a fragrance, which may cause it to be overwhelming in warm temperatures, therefore an association may exist between temperature and a fragrance. In some embodiments, associations may comprise one or more customer characteristics and may additionally include non-customer data which may be treated as customer characteristics such as environmental data. Additional examples of non-customer data which may be treated as customer characteristics are events or occasions. Associations may be made between fragrances and events and may further be combined with other customer characteristics. The customer characteristics and/or fragrance preferences of one or more friends or contacts on social media platforms, or identifiable via other means such as phone or email contacts, may be treated as customer characteristics when identifying associations such that they are applicable to the customer's own fragrance preferences when the friends or contacts are in proximity to the customer. For example, an association may be comprised of a customer's preference for a fragrance when in proximity to a Facebook friend. Saving, at step 814, the associations to the association database 122. Determining, at step 816, whether there are more customer characteristics to be analyzed. In an embodiment, there are additional customer characteristics to be analyzed, such as a customer preference for kayaking. As there are more customer characteristics, returning to step 710 and selecting another customer characteristic. In an alternate embodiment, there are no additional customer characteristics to be analyzed. Determining, at step 818, whether there are more fragrances to be analyzed. In an embodiment, there are additional fragrances, fragrance characteristics, ingredients, etc. to be analyzed, such as the fragrance with ID 173, Brit For Her Eau de Parfum. As there are more fragrances to be analyzed, returning to step 708 and selecting another fragrance. In an alternate embodiment, there are not additional fragrances to be analyzed. Returning, at step 820, to the base module 124.

Functioning of the “Parameter Selection Module” will now be explained with reference to FIG. 9. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the parameter selection module 130. The process begins with receiving, at step 902, a prompt from the base module 124. The prompt may include association data from the created by the analysis module 128. The prompt may additionally include instructions pertaining to the type of recommendation engine to be created, for example, whether it is to be used for a group of related fragrances, or alternatively to be used when a type of customer characteristic is identified, such as an interest in outdoor activities.

Querying, at step 904, the fragrance database 116 for one or more fragrances, fragrance characteristics, ingredients, etc. Querying, at step 906, the association database 122 for at least one correlation or association between one or more fragrances, fragrance characteristics, ingredients, etc. and one or more customer characteristics. An association may be a correlation coefficient or any other number quantifying the relationship between a fragrance and a customer characteristic or the probability that a customer characteristic is a predictor of a customer's preference for a fragrance. An association may additionally be a non-numerical representation of the relationship between a customer characteristic and a fragrance, fragrance characteristic, ingredients, etc. An association may include feedback from one or more customers which may increase or decrease the strength of an association. Feedback may be accounted for via the use of regression models such that the greater the quantity of positive feedback, the more strongly a given customer characteristic may be associated with a fragrance. Selecting, at step 908, a fragrance, fragrance characteristic, or fragrance ingredient from the data retrieved from the fragrance database 116. In an embodiment, selecting the fragrance with ID 11, Her Eau de Parfum. Selecting, at step 910, a correlation or association from the data retrieved from the association database 122. The association comprising at least a customer characteristic and identified relationship with a selected fragrance. The identified relationship may comprise an indication of the strength of the relationship which may be quantitative, such as in the case of a correlation coefficient, ordinal, such as a ranking, or subjective, including descriptors such as low, moderate, or high. Determining, at step 912, whether the association is greater than a threshold. In an embodiment, determining whether a correlation coefficient is above a threshold value. A threshold value may be selected by a system administrator which is then used to determine whether a customer characteristic represented by the correlation coefficient should be selected as a parameter. If the correlation coefficient is above the threshold value, the association may be selected as a parameter, otherwise it will not be selected as a parameter. In some embodiments, a select number of associations will be selected, such as the top 100. In other embodiments, a top percentage, such as the top 10% of associations by correlation coefficient will be selected as parameters. In alternate embodiments, correlation coefficients may not be used, and instead, more generalized associations may be used. For example, an association may be selected, such as customers who like kayaking tend to have a preference for the fragrance with ID 11, Her Eau de Parfum, while the same cohort tends not to have a preference for fragrance with ID 174, Brit For Her Eau de Toilette. These associations may be identified by either direct observations of an individual customer, such as by receiving a survey response indicating that they do not like such fragrances and other such feedback or may be aggregated from customer input and feedback from a large selection of collected data. Data may be collected from first party sources such as a mobile device belonging to a customer, or a kiosk in a retail environment, or may be obtained from one or more third-party sources. Third-party sources may comprise databases, APIs, and other sources of stored or streamed data including social media networks. Social media data may be utilized to identify a customer's interests, such as that they enjoy kayaking, based upon their responding to kayaking events, having a plurality of pictures of themselves kayaking on their profile or in which they were tagged, and engagement, including likes, comments, and shared posts, relating to kayaking. Social media data may be used to increase or decrease the strength of an association which has already been identified by other means, such as by increasing its relative weighting. In the case of aggregated data, the association may be identified if more than half of relevant customers, such as those who were identified as enjoying kayaking, liked fragrance with ID 11. An association would not be identified if fewer than half of customers in the same cohort indicated that they preferred the fragrance. The threshold may be moved and, in some cases, may be subjectively assessed and assigned by a human screener. Other algorithms may be used to determine such associations. When associations are identified, they may be selected as a parameter, otherwise they may be disregarded. In some embodiments, associations may comprise a plurality of customer characteristics and/or fragrances. Selecting, at step 914, the customer characteristic represented by a correlation or association as a parameter if its correlation coefficient is above a threshold value or if there is an association of sufficient significance to be selected by manual selection or other selection algorithms or criteria. For example, selecting ‘enjoying kayaking’ as a parameter which can be used to identify customers with a preference for the fragrance with ID 11. In some embodiments, a single parameter may be used to make a recommendation. In other embodiments, a plurality of parameters may be used, such as in a decision tree or lookup table. In further embodiments, parameters may be selected to be used to train a machine learning algorithm or to modify the weighting for a weighted values table or process to generate fragrance recommendations. In some embodiments, a parameter may comprise a personality trait, emotion, reaction, etc. which may indicate a preference for the selected fragrance. Selecting the parameter and fragrance may comprise adding the personality trait, emotion, reaction, etc. to a lookup table associated with the selected fragrance, or alternatively may adjust a value weighting to be used in determining whether to recommend the fragrance based upon the parameter. Parameters may be identified based upon a single customer's data or alternatively may be based upon aggregate customer data. In such embodiments, customers may be grouped into a plurality of categories such that customers in the same group share similar or identical characteristics, such as personality, interests, hobbies, style preferences, etc. It should be noted that parameters may be identified and selected independently or in combination with one or more additional parameters. Determining, at step 916, whether there are more associations to be analyzed. In an embodiment, there are additional associations to be analyzed, therefore returning to step 810, and selecting another correlation or association. In an alternate embodiment, there are no additional correlations or associations to be analyzed. Determining, at step 918, whether there are more fragrances to be analyzed. In an embodiment, there are additional fragrances, fragrance characteristics, ingredients, etc. to be analyzed, such as the fragrance with ID 173, Brit For Her Eau de Parfum. As there are more fragrances to be analyzed, returning to step 808 and selecting another fragrance. In an alternate embodiment, there are not additional fragrances to be analyzed. Returning, at step 920, the selected parameters to the base module 124.

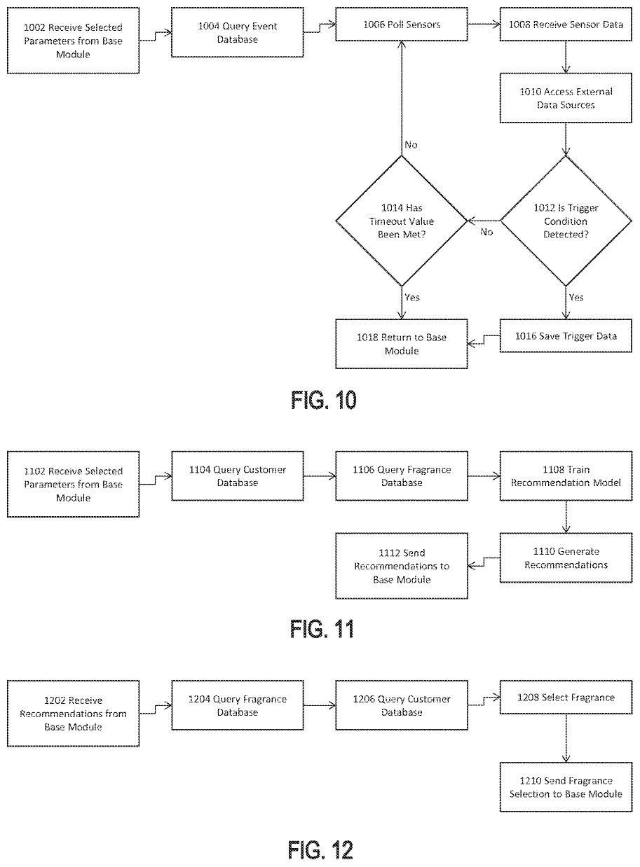

Functioning of the “Real Time Data Module” will now be explained with reference to FIG. 10. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the real time data module 132. The process begins with receiving, at step 1002, the selected parameters from the base module 124. The selected parameters may comprise one or more trigger conditions or parameters to monitor for change. Querying, at step 1004, the event database 120 for one or more trigger conditions. A trigger condition may comprise any of a scheduled event, proximity to a person, location, or object, the detection of an environmental factor such as temperature, humidity, a fragrance, precipitation, etc. Trigger conditions may additionally comprise an activity being performed by or anticipated to be performed by a customer or a detected personality trait, mood, or change in a personality trait or mood. Trigger conditions indicate that a fragrance should be recommended and/or selected. In an embodiment, a trigger condition may comprise a contact, John Smith, of a customer, Jane Doe, being detected within 100 feet of each other based upon the location of each of their mobile devices, and therefore when the two mobile devices are located less than 100 feet apart, the trigger condition is met. In alternate embodiments, a trigger condition may be a scheduled event. For example, a trigger condition for customer, John Smith may be if the time is within 30 minutes of a scheduled meeting with Jane Doe. Other trigger conditions may comprise the detection of a sound, such as a song, or a gesture or facial expression of the customer which may indicate an emotion or mood, such as happy or sad. Polling, at step 1006, one or more sensors 104, cameras 106, microphones 108, input devices 110, etc. for data. Sensors 104 are polled continuously, or at regular intervals, to collect data about one or more customers. The sensors 104, cameras 106, microphones 108, etc. may be standalone devices or may be integrated into an electronic device 102 such as a mobile phone, tablet, wearable device such as a smart watch or fitness tracker or may be external to the customer. A sensor 104, camera 106, microphone 108, etc. may belong to a third party, such as in the case of a security camera, or a weather station. In some embodiments, third party data sources may also be polled for data, such as calendars, social media feeds, news sites, etc. Likewise, time may also be monitored, so as to detect the proximity to the start time of a scheduled event. Receiving, at step 1008, data from one or more sensors 104, cameras 106, microphones 108, input devices 110, or additional data sources such as calendars, social media services, news feeds, weather updates, etc. The data may comprise actively collected data, such as providing prompts or instructions to a customer to provide information such as by an input device 110. In an ideal embodiment, the data is primarily collected via passive means, such as monitoring one or more data streams from one or more sensors 104, cameras 106, microphones 108, input devices 110, or connected data sources. Sensor 104 data may comprise biometrics such as heart rate, blood pressure, respiration rate, galvanic skin response, body temperature, etc. Sensors 104 may additionally detect location and/or movement, such as via global positioning system (GPS), accelerometers, etc. or fragrances, such as via assays, mass spectrometry, etc. Camera 106 data may come from one or more cameras 106 belonging to a customer or one or more third parties, such as other customers, security cameras, kiosks, etc. Cameras 106 may be used to collection information including facial tracking, gestures, eye tracking, and may additionally be used to infer the customer's personality and/or mood. In some embodiments, a customer's preference may be inferred based on demonstrated interest in a product containing a fragrance such as may be demonstrated by subtle cues such as their eye gaze being drawn to such products and may further be paired with the customer's reaction as observed via facial analysis or body language to identify a positive reaction to the fragrance. Further, one or more microphones which may belong to a customer or one or more third parties. Microphone 108 data may be used to receive voice input, to detect personality and/or mood, environmental factors such as the volume of ambient sounds, vocal recognition of other customers, types of ambient sounds such as flowing water, animal sounds, traffic, music, etc. Input devices 110 may be used to actively collect data from a customer. In some embodiments, an input device 110 may comprise a wearable device configured to detect gestures which may facilitate the passive collection of gestures which may similarly be used to infer a personality or mood, such that gestures may be unique for a customer who is excited, versus happy, versus angry, versus sad. The data may be received in real time or near real time such as live data streams. The data may or may not be processed in real time, wherein the processing time would be minimized to the inherent latency involved in data communications and processing. Sensor data may additionally comprise temperature data collected from a mobile device, or a plurality of sensors 104. The temperature may be the customer's temperature or the environmental temperature. Accessing, at step 1010, data from one or more external data sources. External data sources may comprise data sources external to an electronic device 102 and may additionally comprise third party data. Third party data may comprise a connected device comprising a plurality of sensors 104, cameras 106, microphones 108, and input devices 110. Third party data sources may additionally comprise databases and/or data streams or feeds owned and managed by a third party such as those managed by social media providers. In an embodiment, the Data collection module 126 accessing social media data from Facebook and Twitter and identifying one or more posts made by a customer's friends, followers, and people the customer is following and additionally collecting public posts made by the customer and by the customer's friends, followers, etc. which mention or tag the customer in real time. Third party data may also comprise real time sales and returns data from one or more vendors for fragrances as well as clothing, cosmetics, personal care products, etc. Third party data may further relate to a customer's location, geography, climate, weather, and calendar data, including from public and private calendars. In an embodiment, connecting to a retailer's database and confirming that a female customer with customer ID 27046 purchased Her Eau de Parfum 30 seconds ago. Real time refers to the collection and/or processing of data within a minimal amount of time absent inherent delays or latency. For example, real time data processing refers to accessing and processing data immediately upon it being made available. A social media network may only refresh its data feeds every five minutes, therefore real time in such an example would refer to a data feed updating every five minutes. The data processing may be, but is not necessarily, performed in real time. In some embodiments, external data sources may comprise environmental data such as real time updates to weather forecasts. Determining, at step 1012, whether a trigger condition has been detected. If a trigger condition has been detected, saving the trigger data to the event database 120. If a trigger condition has not been detected, determining whether a timeout value has been met, or returning to step 1006 and continuing to poll sensors 104. A trigger condition may be an explicit scenario, such as a detected proximity to a person, location, object, etc. or may be abstract, such as a detected change in the value of a selected parameter. For example, a selected parameter may be mood, as identified by a customer's movements, gestures, and/or facial expressions. If a trigger condition is a change in mood, the trigger condition will be met if a customer who is initially identified to be in a happy mood, is then detected to be in a sad mood. Likewise, when an abstract trigger condition is being monitored, a specific condition may not need to be met. For example, a change in mood may not be dependent on the initial or resulting mood, but rather only require that the detected mood has changed. In additional embodiments, a trigger condition may comprise a change in the weather. In some embodiments, any change may comprise a trigger condition, while in other embodiments, a specific condition must be met, such as a temperature rise above 80° F., or detected or anticipated precipitation, or a rise in humidity above 70%, etc. For example, John Smith may have a scheduled meeting with Jane Doe at 3:00 pm, and if a trigger condition exists defined as a time within 30 minutes of a scheduled meeting with Jane Doe, then after 2:30 pm, the trigger condition will be met and detected. Determining, at step 1012, whether a timeout value has been met. A timeout value may indicate a period of time during which the one or more sensors 104, cameras 106, microphones 108, input devices 110, or other data sources should be monitored for new data. A timeout value may be optional and is not required to practice the invention. In some embodiments, the loss of connection to one or more sensors 104, cameras 106, microphones 108, input devices 110, or other data sources may equivalent to meeting a timeout value. Likewise, each such device or data source may have an independent connection and may have independent timeout values or termination conditions which may indicate when to stop real time monitoring of the data sources. Saving, at step 1016, the trigger data to the events database 120. The trigger data may comprise only the collected data matching the trigger condition. In other embodiments, the trigger data may comprise some or all data received from the one or more sensors 104, cameras 106, microphones 108, input devices 110, and other data sources including the trigger condition. Returning, at step 1018, to the base module 124. If a trigger condition was identified, sending the trigger data to the base module 124. If a timeout occurs, then returning the timeout condition to the base module 124.

Functioning of the “Recommendation Module” will now be explained with reference to FIG. 11. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the recommendation module 134. The process begins with receiving, at step 1102, selected parameters from the base module 124. The selected parameters having met a quantitative threshold or have been selected due to an identified association with at least one fragrance preference. Querying, at step 1104, the customer database 118 for customer characteristics corresponding to the selected parameters. For example, a selected parameter may comprise an association between a customer's preference for kayaking and their preference for a fragrance with the ID 11, and the corresponding customer characteristic is the customer preference for kayaking. Additionally retrieving data related to a customer of interest for whom a recommendation is to be generated. The data related to the customer of interest may influence the training of a recommendation model by using only parameters which correspond with the available data describing the customer. For example, if a customer's hobby data is available, then parameters related to hobby preferences would be included in the training data, whereas if social media data is not available for the customer of interest, then social media related parameters would be excluded from the training data. Querying, at step 1106, the fragrance database 116 for available fragrances. The fragrance data may include specific fragrances, but may also include their characteristics, ingredients, etc. Any such data describing a fragrance may be utilized in the generation of a recommendation model. For example, fragrances may ultimately be recommended as a family of fragrances, rather than a specific fragrance. Training, at step 1108, a recommendation model based upon the customer characteristics corresponding with the selected parameters. In a machine learning application, the customer characteristics would correspond to features, or mapped source data used to train the machine learning model. Training a machine learning model typically uses regression by applying an adjustment or correction after each successive training test. Several evolutions may be completed, with a reserved selection of training data reserved as test data to facilitate assessment of the trained model's accuracy. The evolutions may continue until the model's predictive accuracy is above a threshold value, such as 95%. The reserved training data may be changed, being randomly reselected between each evolution. In such embodiments, feedback data such as data acquired by the feedback module 138 and stored in the customer database 118 may be required to demonstrate an association with a fragrance. In one example, the weighting of a given customer characteristic as a parameter in predicting an individual's preference for at least one fragrance is increased or decreased based on feedback on the correlation between the customer characteristic and customer feedback. A recommendation model may alternatively be based upon a lookup table or decision tree. In a lookup table, one or more customer characteristics based upon the selected parameters may be used to map directly to one or more fragrances based on customer feedback. In some cases, multiple lookup tables may be available using different combinations of the selected parameters. For example, some tables may use personality traits, while others may use hobbies or interests. Further tables may comprise occasions, while others may comprise a combination of interests and occasions. These tables may be formed by using the selected parameters to map the fragrances to customer characteristics. A decision tree may be created similarly to lookup tables, except instead of looking up matches, a series of branching decisions may be used instead. For example, one decision tree may comprise the user's interests, while another may be the occasion, and a further decision may be the user's stated fragrance preferences. Similar to the lookup tables, the decision tree branching points may be determined based upon a mapping of fragrances to customer characteristics. The selected parameters may be used to modify weightings in a weighted values approach such that a lookup table or algorithm is used where matched customer characteristics may increase or decrease a preference likelihood or customer feedback for one or more fragrances. Generating, at step 1110, one or more fragrance recommendations based upon the trained recommendation model and data collected for a customer. The generated recommendations may comprise one or more specific fragrances or may alternatively comprise one or more families of fragrances such that the fragrances in a family possess similar qualities. Likewise, recommendations may be based upon specific ingredients in the fragrances or common characteristics. In some embodiments, recommendations are based upon personality type. In other embodiments, recommendations are based upon declarative preferences of the customer for specific olfactive components or ingredients (e.g., “I prefer floral scents like peony”), including recommendations based on specific fragrances the customer has indicated they currently use or prefer. In further embodiments, recommendations are based upon recommending fragrances with new ingredients that have similar olfactive properties and characteristics. In another embodiment, recommendations are based upon ingredients that are similar to ingredients in the customer's current or preferred fragrance. In other embodiments, recommendations may use a weighting method (singly or in combination) such that preferences and characteristics (such as personality type, mood, an occasion, etc.) are given more or less influence in the rating based upon the olfactive properties or ingredient compositions of fragrances the customer has indicated they prefer or currently use. Fragrance recommendations may comprise a binary recommended vs not recommended decision or may additionally provide a score, for example, each recommended fragrance comprising a likelihood of customer preference out of a score of 10, and recommended fragrances may be any fragrance with a score above a threshold, such as 8/10. These scores may further be used to select one or more fragrances from the recommended fragrances. In an embodiment, determining that a customer being female makes them more likely to prefer Her Eau de Parfum. In another embodiment, identifying that a customer characteristic of a fruity fragrance preferences indicates an increased preference for My Burberry Eau de Toilette. In some embodiments, multiple customer characteristics may be considered together, such as females with seductive personalities have a preference for Her Eau de Parfum. The recommendation model, regardless of the type, whether utilizing machine learning, lookup tables, decision trees, or weighted values, may categorize customers into a plurality of categories wherein customers with similar interests, preferences, features, personalities, etc. may be recommended the same or similar fragrances. In some embodiments, similar fragrances may be recommended based upon similar users who like the same fragrances, whereas in other embodiments, a fragrance may be recommended as having similar olfactive properties as those identified as preferred by the customer or the category of customers in which the customer was determined to belong. Alternatively, fragrances may be recommended based upon similar fragrance ingredients. These ingredients may be preferred or contraindicated, such as in the case of an identified allergy or sensitivity. In some embodiments, recommendations may comprise one or more fragrance components which may be combined to create a personalized fragrance. In such embodiments, where fragrances have been previously defined, a fragrance component may instead be used to identify associations or correlations between fragrance components and customer characteristics to generate one or more combinations of fragrance components which may comprise a personalized fragrance. Not all recommended fragrance components may be included in a personalized fragrance, and in some embodiments, a preformulated fragrance may be selected or recommended based upon a combination of a plurality of recommended fragrance components. Sending, at step 1112, the one or more fragrance recommendations to the base module 124.

Functioning of the “Fragrance Selection Module” will now be explained with reference to FIG. 12. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the fragrance selection module 136. The process begins with receiving, at step 1202, one or more fragrance recommendations from the base module 124. The one or more fragrance recommendations may comprise specific fragrances or groups of fragrances based upon commonalities. Querying, at step 1204, the fragrance database 116 for one or more fragrances corresponding with the fragrance recommendations received from the base module 124. For example, if a group of fragrances was recommended, then identifying each unique fragrance within the group of fragrances as eligible for selection. Querying, at step 1206, the customer database 118, for specific fragrance preferences or information regarding the current recommendation. For example, if the customer desires a new fragrance for an upcoming party and/or would prefer a mild fragrance which would not clash with the scent or flavors of a dinner. Selecting, at step 1208, a fragrance from the fragrance recommendations based upon the customer's preferences. In some embodiments, multiple fragrances may be selected. The fragrance may be selected by automated means using one or more algorithms or may instead be selected manually by a purveyor or the customer. In some embodiments, multiple fragrances may be selected with the intent of blending them into a new fragrance. In alternate embodiments, multiple fragrances may be selected with the intent to send the customer a plurality of fragrances instead of a single fragrance. In some embodiments, a fragrance may be selected using customer data and a weighted values method such as a lookup table or algorithm. In other embodiments, multiple fragrances may be selected based on multiple, differentiated decision pathways as described in FIG. 9. Fragrances may be selected based upon a customer's data being used to make a prediction using a machine learning algorithm to select from the recommended fragrances. Further embodiments may select a fragrance based on similar characteristics to the customer's preferences including a similar olfactive and ingredients. In some embodiments, a fragrance recommendation may include a score indicating the likelihood the fragrance is preferred by a customer. Fragrances may be selected based upon this score, such as the highest scoring fragrance or where multiple fragrances are selected, the top “n” fragrances with the highest recommendation scores. In some embodiments, selecting a fragrance may comprise selecting a combination of recommended fragrance components to create a personalized fragrance. This selection may be fully automated and may additionally comprise simulations to predict one or more characteristics of the personalized fragrance. Alternatively, the selection may be performed by a professional, to create a personalized fragrance. In further embodiments, selecting a fragrance may comprise creating a plurality of sample personalized fragrances based upon the recommended fragrance components, which may undergo testing prior to selecting one or more personalized fragrances. Additional fragrance components may be utilized in addition to the recommended fragrance components. It should also be noted that a fragrance recommendation need not be a positive recommendation, but may additionally be a negative recommendation, so as to indicate that a fragrance, or fragrance component, should not be recommended or selected for a customer. Sending, at step 1210, the selected fragrance, or fragrances to the base module 124.

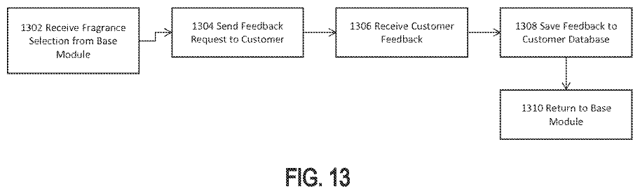

Functioning of the “Feedback Module” will now be explained with reference to FIG. 13. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the feedback module 138. The process begins with receiving, at step 1302, the fragrance selection from the base module 124. In some embodiments, multiple fragrances may be selected. Receiving the fragrance may comprise providing one or more fragrances to a customer, such as part of a sample to allow the customer to assess the one or more fragrances. In other embodiments, receiving the fragrance may comprise presenting the customer with an opportunity to purchase the one or more fragrances. In another embodiment, the one or more fragrances may be purchased as a gift. In some embodiments, the one or more fragrances may be presented as a notification to the user such as via an email, SMS message, application notification, etc. Said notification or opportunity to purchase may additionally comprise an incentive to buy, such as a discount, rebate, money back guarantee, etc. In a preferred embodiment, the one or more fragrances are selected and provided based upon parameters and/or recommendations customized based upon the customer's available customer characteristics. Sending, at step 1304, a feedback request to the customer. The feedback request may pertain to the selected fragrance or may alternatively be a general inquiry. Examples of a feedback request may be a customer satisfaction survey delivered via mail or email. The feedback request is optional and is not required to practice the invention. The customer may alternatively voluntarily share their feedback via behaviors, such as returning a product or purchasing a product again, or by voluntarily submitting a review, complaint, etc. Receiving, at step 1306, feedback from a customer. Feedback may be explicit, such as from a survey response, review, complaint, etc. or may be obtained passively by observing actions taken by the customer such as whether they purchase a product containing a fragrance, which would indicate a positive response or preference, especially if repeatedly purchasing one or more products with the same fragrance, whereas the customer returning a product with a specific fragrance may indicate a negative response or preference. Customer feedback may also be available via social media posts including mentions, shares, recommendations, and critical reviews. In some embodiments, a plurality of fragrances may be presented to the customer and the customer provides feedback regarding their preferences. The feedback may comprise a ranking of the provided fragrances from most preferred to least preferred. The feedback may alternatively be binary, such as preferred or not preferred, liked, or disliked, etc. The feedback may alternatively be an independent scoring, such as 8/10 where 10/10 would represent the highest possible preference and 0/10 would represent the worst or lowest possible preference. Saving, at step 1308, the customer feedback to the customer database 118. Information accumulated in customer database 118 can be used to further refine any of the activities described in FIGS. 6 through 10 for analysis, association, recommendation, or selection of fragrances. In one example, the weighting of a given characteristic as a parameter in predicting an individual's preference for at least one fragrance is increased or decreased based on feedback on the correlation between the characteristic and customer feedback. Returning, at step 1310, to the base module 124.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

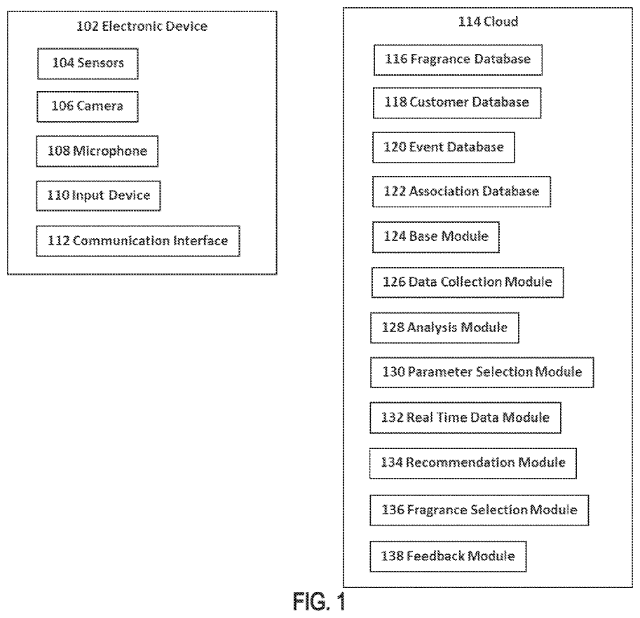

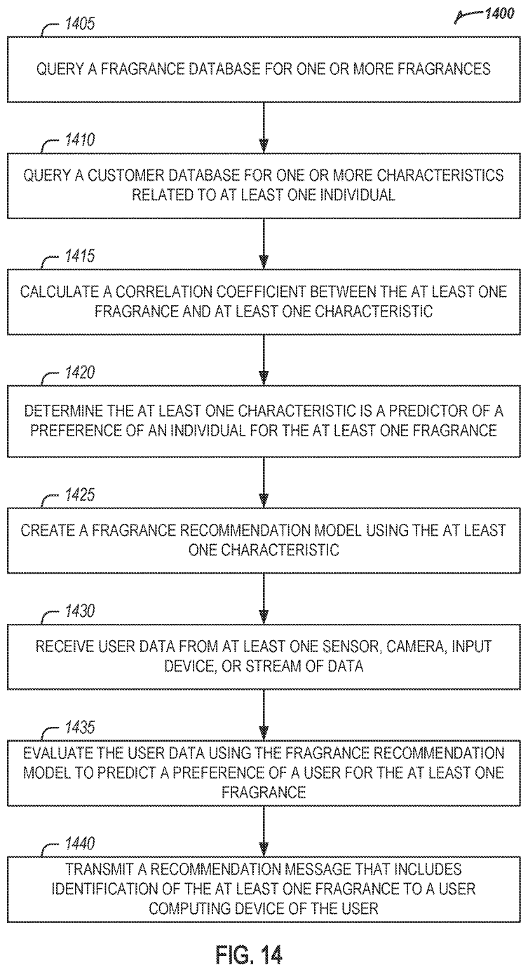

FIG. 14 is a flow diagram of an example of a method 1500 for a fragrance recommendation, according to an embodiment. The method 1400 may provide features as described in FIGS. 1 to 13.

At operation 1405, a fragrance database is queried for one or more fragrances. At operation 1410, a customer database is queried for one or more characteristics related to at least one individual. In an example, emotional state data may be obtained that includes at least a facial expression, a gesture, a tone of voice, a message context, or a biometric data element from the at least one sensor, camera, input device, or stream of data and the emotional state data may be evaluated to determine a current emotional state of the user. The characteristic may be an emotional state and the preference of the user is predicted in part using the current emotional state of the user. In an example, the at least one characteristic may include facial features. One or more images of a face of the user may be captured from a camera. User facial features may be identified in the one or more images and the preference of the user may be predicted in part using the user facial features. In an example, the at least one characteristic may be a demographic parameter, a user preference parameter, or a user action parameter. In an example, the at least one characteristic may include at least one human parameter and at least one non-human parameter.

At operation 1415, a correlation coefficient is calculated between the at least one fragrance and at least one characteristic. At operation 1420, it is determined that the at least one characteristic is a predictor of a preference of an individual for the at least one fragrance. In an example, the at least one characteristic may be determined to be a predictor of the preference of the individual for the at least one fragrance based on the correlation coefficient being outside a threshold. In an example, the at least one characteristic may be determined to be a predictor of the preference of the individual for the at least one fragrance based on the correlation coefficient for the at least one characteristic having a higher value that a second correlation coefficient for another characteristic.

At operation 1425, a fragrance recommendation model is created using the at least one characteristic. At operation 1430, user data is received from at least one sensor, camera, input device, or stream of data. In an example, user personality data may be obtained that includes user activity metrics and user preferences. The personality data may be evaluated to determine a personality type for the user. Personality characteristics may be determined for the user based on the personality type and the personality characteristics may be added to the user data. In an example, a social media profile of the user may be identified. Social network engagement data may be obtained for the user based on the social media profile. The social network engagement data may be evaluated to determine user characteristics for the user and the user characteristics may be added to the user data. In an example, the at least one characteristic may include a volatile organic compound (VOC) attribute. An air sample may be collected using a VOC sensor. The air sample may be evaluated to identify concentrations of a set of VOCs. The fragrance database may be queried using the concentrations of the set of VOCs to identify a present fragrance. Fragrance attributes may be obtained for the present fragrance from the fragrance database and the fragrance attribute may be added to the user data. In an example, social proximity data may be obtained for the user. The social proximity data may be evaluated to identify a connection between the user and a connection. Connection data may be collected for the connection. Connection characteristics may be extracted from the connection data and the connection characteristics may be added to the user data.

At operation 1435, the user data is evaluated using the fragrance recommendation model to predict a preference of a user for the at least one fragrance upon detection of a trigger condition in the user data. In an example, user provided data may be obtained via an input device of the user computing device and the user provided data may be evaluated using the fragrance recommendation model in conjunction with the user data. In an example, stimuli may be presented via an output device of the user computing device. User biometric data may be obtained from a biometric sensor and the user biometric data may be evaluated to determine a physical response to the stimuli. The preference may be predicted in part based on the physical response. In an example, a genetic sample of the user may be obtained. The genetic sample may be sequenced to determine an allergen profile for the user and a predicted pheromone preference for the user and the preference may be predicted in part using the allergen profile and the predicted pheromone preference. In an example, the fragrance recommendation model may include an environment-fragrance chemical composition feature. Environmental data may be obtained for a proximate area of the user from an environmental sensor. The environmental data may be added to the user data and the preference may be predicted in part based on a prediction of suitability of the at least one fragrance to the proximate area based on an evaluation of the environmental data and the chemical composition of the at least one fragrance. In an example, the at least one characteristic may include user types. The user data may be evaluated to assign a user type to the user and the preference may be predicted in part using the user type. In an example, a video feed may be obtained from an image sensor. The video feed may be processed using an artificial intelligence processor to identify an emotional reaction of the user to a stimuli present in the video feed. An emotive reaction attribute may be generated for the user based on the identified emotional reaction. The fragrance recommendation model may include an emotive reaction feature and the preference may be predicted in part using the emotive reaction attribute. In an example, the fragrance recommendation model may include a fragrance ingredient-characteristic feature. An ingredient list may be obtained for the at least one fragrance and the preference may be predicted in part based on evaluation of the ingredient list in conjunction with the user data. In an example, an event may be identified in the user data. The user data may be evaluated to collect event data. Event attributes may be extracted from the event data and the event attributes may be evaluated in conjunction with the user data using the fragrance recommendation model.

At operation 1440, a recommendation message is transmitted that includes identification of the at least one fragrance to a user computing device of the user. In an example, visual stimuli associated with the at least one fragrance may be presented to the display of the user computing device. An image of eyes of the user may be obtained from a camera. The image may be evaluated to determine a vector of a gaze of the user and a fragrance of interest may be determined based on the vector of the gaze. The recommendation message may include an identity of the fragrance of interest.

In an example, a characteristic may be obtained for a plurality of individuals from the customer database. An association between the characteristic and a fragrance from the fragrance database may be determined based on and evaluation of customer data for the plurality of individuals. The association between the characteristic and the fragrance may be stored in an association database and it may be determined that the at least one characteristic is a predictor of the preference of the individual based on an assessment of the association database.

In an example, at least one fragrance sample may be selected based on the identification of the at least one fragrance and a fulfillment request may be electronically transmitted to an enterprise resource planning system that includes a request for the at least one fragrance sample and a delivery address for the user.

In an example, a personality fragrance prediction model may be trained using a corpus of training data that includes personality traits and corresponding fragrance preferences. A fragrance attribute of a fragrance from the fragrance database may be evaluated using the personality fragrance prediction model to predict one or more personality traits associated with the fragrance attribute and the predicted one or more personality traits associated with the fragrance attribute may be stored in the fragrance database.

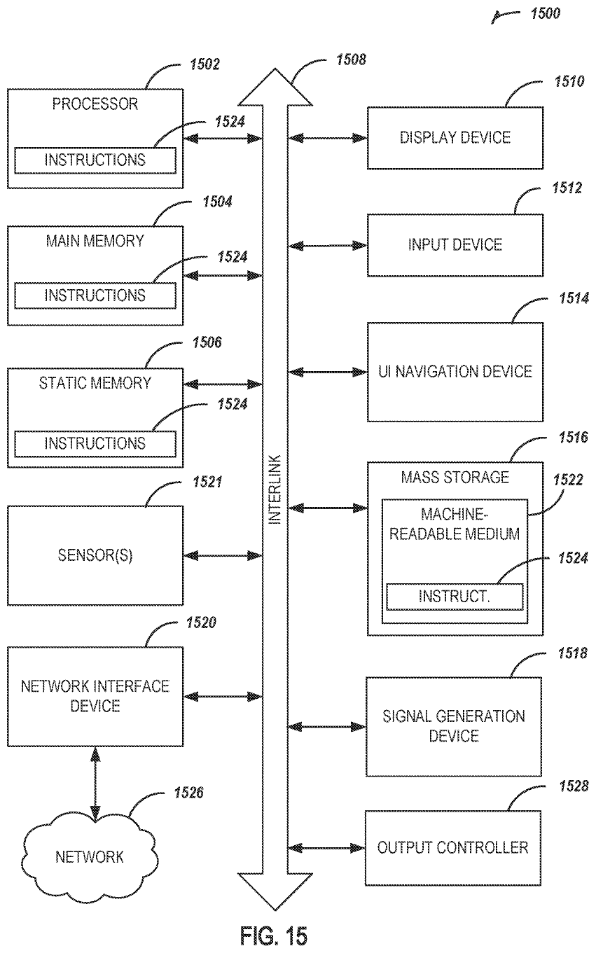

FIG. 15 illustrates a block diagram of an example machine 1500 upon which any one or more of the techniques (e.g., methodologies) discussed herein may perform. In alternative embodiments, the machine 1500 may operate as a standalone device or may be connected (e.g., networked) to other machines. In a networked deployment, the machine 1500 may operate in the capacity of a server machine, a client machine, or both in server-client network environments. In an example, the machine 1500 may act as a peer machine in peer-to-peer (P2P) (or other distributed) network environment. The machine 1500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1500 may include a hardware processor 1502 (e.g., a central processing unit (CPU), a graphics processing unit (GPU), a hardware processor core, or any combination thereof), a main memory 1504 and a static memory 1506, some or all of which may communicate with each other via an interlink (e.g., bus) 1508. The machine 1500 may further include a display unit 1510, an alphanumeric input device 1512 (e.g., a keyboard), and a user interface (UI) navigation device 1514 (e.g., a mouse). In an example, the display unit 1510, input device 1512 and UI navigation device 1514 may be a touch screen display. The machine 1500 may additionally include a storage device (e.g., drive unit) 1516, a signal generation device 1518 (e.g., a speaker), a network interface device 1520, and one or more sensors 1521, such as a global positioning system (GPS) sensor, compass, accelerometer, or other sensors. The machine 1500 may include an output controller 1528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1516 may include a machine readable medium 1522 on which is stored one or more sets of data structures or instructions 1524 (e.g., software) embodying or utilized by any one or more of the techniques or functions described herein. The instructions 1524 may also reside, completely or at least partially, within the main memory 1504, within static memory 1506, or within the hardware processor 1502 during execution thereof by the machine 1500. In an example, one or any combination of the hardware processor 1502, the main memory 1504, the static memory 1506, or the storage device 1516 may constitute machine readable media.

While the machine readable medium 1522 is illustrated as a single medium, the term “machine readable medium” may include a single medium or multiple media (e.g., a centralized or distributed database, and/or associated caches and servers) configured to store the one or more instructions 1524.

The term “machine readable medium” may include any medium that is capable of storing, encoding, or carrying instructions for execution by the machine 1500 and that cause the machine 1500 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1524 may further be transmitted or received over a communications network 1526 using a transmission medium via the network interface device 1520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 1520 may include one or more physical jacks (e.g., Ethernet, coaxial, or phone jacks) or one or more antennas to connect to the communications network 1526. In an example, the network interface device 1520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1500, and includes digital or analog communications signals or other intangible medium to facilitate communication of such software.

### Additional Examples

Example 1 is a method executable by computing circuitry comprising: querying a fragrance database for one or more fragrances; querying a customer database for one or more characteristics related to at least one individual; calculating a correlation coefficient between the at least one fragrance and at least one characteristic; determining the at least one characteristic is a predictor of a preference of an individual for the at least one fragrance; creating a fragrance recommendation model using the at least one characteristic; receiving user data from at least one sensor, camera, input device, or stream of data; upon detection of a trigger condition in the user data, evaluating the user data using the fragrance recommendation model to predict a preference of a user for the at least one fragrance; and transmitting a recommendation message that includes, identification of the at least one fragrance to a user computing device of the user.

In Example 2, the subject matter of Example 1 includes, obtaining a characteristic for a plurality of individuals from the customer database; determining an association between the characteristic and a fragrance from the fragrance database based on and evaluation of customer data for the plurality of individuals; storing the association between the characteristic and the fragrance in an association database; and determining that the at least one characteristic is a predictor of the preference of the individual based on an assessment of the association database.

In Example 3, the subject matter of Examples 1-2 includes, obtaining emotional state data including at least a facial expression, a gesture, a tone of voice, a message context, or a biometric data element from the at least one sensor, camera, input device, or stream of data; and evaluating the emotional state data to determine a current emotional state of the user, wherein the characteristic is an emotional state and the preference of the user is predicted in part using the current emotional state of the user.

In Example 4, the subject matter of Examples 1-3 includes, presenting visual stimuli associated with the at least one fragrance to the display of the user computing device; obtaining an image of eyes of the user from a camera; evaluating the image to determine a vector of a gaze of the user; and determining a fragrance of interest based on the vector of the gaze, wherein the recommendation message includes an identity of the fragrance of interest.

In Example 5, the subject matter of Examples 1-4 includes, obtaining user provided data via an input device of the user computing device; and evaluating the user provided data using the fragrance recommendation model in conjunction with the user data.

In Example 6, the subject matter of Examples 1-5 includes, presenting stimuli via an output device of the user computing device; obtaining user biometric data from a biometric sensor; and evaluating the user biometric data to determine a physical response to the stimuli, wherein the preference is predicted in part based on the physical response.

In Example 7, the subject matter of Examples 1-6 includes, obtaining user personality data that includes user activity metrics and user preferences; evaluating the personality data to determine a personality type for the user; determining personality characteristics for the user based on the personality type; and adding the personality characteristics to the user data.

In Example 8, the subject matter of Examples 1-7 includes, wherein the at least one characteristic includes facial features and further comprising: capturing one or more images of a face of the user from a camera; and identifying user facial features in the one or more images, wherein the preference of the user is predicted in part using the user facial features.

In Example 9, the subject matter of Examples 1-8 includes, selecting at least one fragrance sample based on the identification of the at least one fragrance; and electronically transmitting a fulfillment request to an enterprise resource planning system that includes a request for the at least one fragrance sample and a delivery address for the user.

In Example 10, the subject matter of Examples 1-9 includes, obtaining a genetic sample of the user; and sequencing the genetic sample to determine an allergen profile for the user and a predicted pheromone preference for the user, wherein the preference is predicted in part using the allergen profile and the predicted pheromone preference.

In Example 11, the subject matter of Examples 1-10 includes, identifying a social media profile of the user; obtaining social network engagement data for the user based on the social media profile; evaluating the social network engagement data to determine user characteristics for the user; and adding the user characteristics to the user data.

In Example 12, the subject matter of Examples 1-11 includes, wherein the fragrance recommendation model includes an environment-fragrance chemical composition feature and further comprising: obtaining environmental data for a proximate area of the user from an environmental sensor; and adding the environmental data to the user data, wherein the preference is predicted in part based on a prediction of suitability of the at least one fragrance to the proximate area based on an evaluation of the environmental data and the chemical composition of the at least one fragrance.

In Example 13, the subject matter of Examples 1-12 includes, wherein the at least one characteristic includes user types and further comprising evaluating the user data to assign a user type to the user, wherein the preference is predicted in part using the user type.

In Example 14, the subject matter of Examples 1-13 includes, obtaining a video feed from an image sensor; processing the video feed using an artificial intelligence processor to identify an emotional reaction of the user to a stimuli present in the video feed; and generating an emotive reaction attribute for the user based on the identified emotional reaction, wherein the fragrance recommendation model includes an emotive reaction feature, and wherein the preference is predicted in part using the emotive reaction attribute.

In Example 15, the subject matter of Examples 1-14 includes, wherein the at least one characteristic includes a volatile organic compound (VOC) attribute and further comprising: collecting an air sample using a VOC sensor; evaluating the air sample to identify concentrations of a set of VOCs; querying the fragrance database using the concentrations of the set of VOCs to identify a present fragrance; obtaining fragrance attributes for the present fragrance from the fragrance database; and adding the fragrance attribute to the user data.

In Example 16, the subject matter of Examples 1-15 includes, obtaining social proximity data for the user; evaluating the social proximity data to identify a connection between the user and a connection; collecting connection data for the connection; extracting connection characteristics from the connection data; and adding the connection characteristics to the user data.

In Example 17, the subject matter of Examples 1-16 includes, wherein the at least one characteristic is a demographic parameter, a user preference parameter, or a user action parameter.

In Example 18, the subject matter of Examples 1-17 includes, wherein the fragrance recommendation model includes a fragrance ingredient-characteristic feature and further comprising obtaining an ingredient list for the at least one fragrance, wherein the preference is predicted in part based on evaluation of the ingredient list in conjunction with the user data.

In Example 19, the subject matter of Examples 1-18 includes, wherein the at least one characteristic include at least one human parameter and at least one non-human parameter.

In Example 20, the subject matter of Examples 1-19 includes, wherein the at least one characteristic is determined to be a predictor of the preference of the individual for the at least one fragrance based on the correlation coefficient being outside a threshold.

In Example 21, the subject matter of Examples 1-20 includes, wherein the at least one characteristic is determined to be a predictor of the preference of the individual for the at least one fragrance based on the correlation coefficient for the at least one characteristic having a higher value that a second correlation coefficient for another characteristic.

In Example 22, the subject matter of Examples 1-21 includes, identifying an event in the user data; evaluating the user data to collect event data; extracting event attributes from the event data; and evaluating the event attributes in conjunction with the user data using the fragrance recommendation model.

In Example 23, the subject matter of Examples 1-22 includes, training a personality fragrance prediction model using a corpus of training data including personality traits and corresponding fragrance preferences; evaluating a fragrance attribute of a fragrance from the fragrance database using the personality fragrance prediction model to predict one or more personality traits associated with the fragrance attribute; and storing the predicted one or more personality traits associated with the fragrance attribute in the fragrance database.

Example 24 is a system comprising means to perform any method of Examples 1-23.

Example 25 is at least one machine-readable medium including instructions that, when executed by a machine, cause the machine to perform any method of Examples 1-23.

Example 26 is a system comprising: at least one processor; and memory comprising instructions that, when executed by the at least one processor, cause the at least one processor to perform operations to: query a fragrance database for one or more fragrances; query a customer database for one or more characteristics related to at least one individual; calculate a correlation coefficient between the at least one fragrance and at least one characteristic;

determine the at least one characteristic is a predictor of a preference of an individual for the at least one fragrance; create a fragrance recommendation model using the at least one characteristic; receive user data from at least one sensor, camera, input device, or stream of data; upon detection of a trigger condition in the user data, evaluate the user data using the fragrance recommendation model to predict a preference of a user for the at least one fragrance; and transmit a recommendation message that includes, identification of the at least one fragrance to a user computing device of the user.

In Example 27, the subject matter of Example 26 includes, the memory further comprising instructions that, when executed by the at least one processor, cause the at least one processor to perform operations to: obtain a characteristic for a plurality of individuals from the customer database; determine an association between the characteristic and a fragrance from the fragrance database based on and evaluation of customer data for the plurality of individuals; store the association between the characteristic and the fragrance in an association database; and determine that the at least one characteristic is a predictor of the preference of the individual based on an assessment of the association database.

In Example 28, the subject matter of Examples 26-27 includes, the memory further comprising instructions that, when executed by the at least one processor, cause the at least one processor to perform operations to: obtain emotional state data including at least a facial expression, a gesture, a tone of voice, a message context, or a biometric data element from the at least one sensor, camera, input device, or stream of data; and evaluate the emotional state data to determine a current emotional state of the user, wherein the characteristic is an emotional state and the preference of the user is predicted in part using the current emotional state of the user.

In Example 29, the subject matter of Examples 26-28 includes, the memory further comprising instructions that, when executed by the at least one processor, cause the at least one processor to perform operations to: present visual stimuli associated with the at least one fragrance to the display of the user computing device; obtain an image of eyes of the user from a camera; evaluate the image to determine a vector of a gaze of the user; and determine a fragrance of interest based on the vector of the gaze, wherein the recommendation message includes an identity of the fragrance of interest.

In Example 30, the subject matter of Examples 26-29 includes, the memory further comprising instructions that, when executed by the at least one processor, cause the at least one processor to perform operations to: obtain user provided data via an input device of the user computing device; and evaluate the user provided data using the fragrance recommendation model in conjunction with the user data.

In Example 31, the subject matter of Examples 26-30 includes, the memory further comprising instructions that, when executed by the at least one processor, cause the at least one processor to perform operations to: present stimuli via an output device of the user computing device; obtain user biometric data from a biometric sensor; and evaluate the user biometric data to determine a physical response to the stimuli, wherein the preference is predicted in part based on the physical response.

In Example 32, the subject matter of Examples 26-31 includes, the memory further comprising instructions that, when executed by the at least one processor, cause the at least one processor to perform operations to: obtain user personality data that includes user activity metrics and user preferences; evaluate the personality data to determine a personality type for the user; determine personality characteristics for the user based on the personality type; and add the personality characteristics to the user data.

In Example 33, the subject matter of Examples 26-32 includes, wherein the at least one characteristic includes facial features and the memory further comprising instructions that, when executed by the at least one processor, cause the at least one processor to perform operations to: capture one or more images of a face of the user from a camera; and identify user facial features in the one or more images, wherein the preference of the user is predicted in part using the user facial features.

In Example 34, the subject matter of Examples 26-33 includes, the memory further comprising instructions that, when executed by the at least one processor, cause the at least one processor to perform operations to: select at least one fragrance sample based on the identification of the at least one fragrance; and electronically transmit a fulfillment request to an enterprise resource planning system that includes a request for the at least one fragrance sample and a delivery address for the user.

In Example 35, the subject matter of Examples 26-34 includes, the memory further comprising instructions that, when executed by the at least one processor, cause the at least one processor to perform operations to: obtain a genetic sample of the user; and sequence the genetic sample to determine an allergen profile for the user and a predicted pheromone preference for the user, wherein the preference is predicted in part using the allergen profile and the predicted pheromone preference.

In Example 36, the subject matter of Examples 26-35 includes, the memory further comprising instructions that, when executed by the at least one processor, cause the at least one processor to perform operations to: identify a social media profile of the user; obtain social network engagement data for the user based on the social media profile; evaluate the social network engagement data to determine user characteristics for the user; and add the user characteristics to the user data.

In Example 37, the subject matter of Examples 26-36 includes, wherein the fragrance recommendation model includes an environment-fragrance chemical composition feature and the memory further comprising instructions that, when executed by the at least one processor, cause the at least one processor to perform operations to: obtain environmental data for a proximate area of the user from an environmental sensor; and add the environmental data to the user data, wherein the preference is predicted in part based on a prediction of suitability of the at least one fragrance to the proximate area based on an evaluation of the environmental data and the chemical composition of the at least one fragrance.

In Example 38, the subject matter of Examples 26-37 includes, wherein the at least one characteristic includes user types and the memory further comprising instructions that, when executed by the at least one processor, cause the at least one processor to perform operations to evaluate the user data to assign a user type to the user, wherein the preference is predicted in part using the user type.

In Example 39, the subject matter of Examples 26-38 includes, the memory further comprising instructions that, when executed by the at least one processor, cause the at least one processor to perform operations to: obtain a video feed from an image sensor; process the video feed using an artificial intelligence processor to identify an emotional reaction of the user to a stimuli present in the video feed; and generate an emotive reaction attribute for the user based on the identified emotional reaction, wherein the fragrance recommendation model includes an emotive reaction feature, and wherein the preference is predicted in part using the emotive reaction attribute.

In Example 40, the subject matter of Examples 26-39 includes, wherein the at least one characteristic includes a volatile organic compound (VOC) attribute and the memory further comprising instructions that, when executed by the at least one processor, cause the at least one processor to perform operations to: collect an air sample using a VOC sensor; evaluate the air sample to identify concentrations of a set of VOCs; query the fragrance database using the concentrations of the set of VOCs to identify a present fragrance; obtain fragrance attributes for the present fragrance from the fragrance database; and add the fragrance attribute to the user data.

In Example 41, the subject matter of Examples 26-40 includes, the memory further comprising instructions that, when executed by the at least one processor, cause the at least one processor to perform operations to: obtain social proximity data for the user; evaluate the social proximity data to identify a connection between the user and a connection; collect connection data for the connection; extract connection characteristics from the connection data; and add the connection characteristics to the user data.

In Example 42, the subject matter of Examples 26-41 includes, wherein the at least one characteristic is a demographic parameter, a user preference parameter, or a user action parameter.

In Example 43, the subject matter of Examples 26-42 includes, wherein the fragrance recommendation model includes a fragrance ingredient-characteristic feature and the memory further comprising instructions that, when executed by the at least one processor, cause the at least one processor to perform operations to obtain an ingredient list for the at least one fragrance, wherein the preference is predicted in part based on evaluation of the ingredient list in conjunction with the user data.

In Example 44, the subject matter of Examples 26-43 includes, wherein the at least one characteristic include at least one human parameter and at least one non-human parameter.

In Example 45, the subject matter of Examples 26-44 includes, wherein the at least one characteristic is determined to be a predictor of the preference of the individual for the at least one fragrance based on the correlation coefficient being outside a threshold.

In Example 46, the subject matter of Examples 26-45 includes, wherein the at least one characteristic is determined to be a predictor of the preference of the individual for the at least one fragrance based on the correlation coefficient for the at least one characteristic having a higher value that a second correlation coefficient for another characteristic.

In Example 47, the subject matter of Examples 26-46 includes, the memory further comprising instructions that, when executed by the at least one processor, cause the at least one processor to perform operations to: identify an event in the user data; evaluate the user data to collect event data; extract event attributes from the event data; and evaluate the event attributes in conjunction with the user data using the fragrance recommendation model.

In Example 48, the subject matter of Examples 26-47 includes, the memory further comprising instructions that, when executed by the at least one processor, cause the at least one processor to perform operations to: train a personality fragrance prediction model using a corpus of training data including personality traits and corresponding fragrance preferences; evaluate a fragrance attribute of a fragrance from the fragrance database using the personality fragrance prediction model to predict one or more personality traits associated with the fragrance attribute; and store the predicted one or more personality traits associated with the fragrance attribute in the fragrance database.

Example 49 is at least one non-transitory machine-readable medium comprising instructions that, when executed by at least one processor, cause the at least one processor to perform operations to: query a fragrance database for one or more fragrances; query a customer database for one or more characteristics related to at least one individual; calculate a correlation coefficient between the at least one fragrance and at least one characteristic; determine the at least one characteristic is a predictor of a preference of an individual for the at least one fragrance; create a fragrance recommendation model using the at least one characteristic; receive user data from at least one sensor, camera, input device, or stream of data; upon detection of a trigger condition in the user data, evaluate the user data using the fragrance recommendation model to predict a preference of a user for the at least one fragrance; and transmit a recommendation message that includes, identification of the at least one fragrance to a user computing device of the user.

In Example 50, the subject matter of Example 49 includes, instructions that, when executed by the at least one processor, cause the at least one processor to perform operations to: obtain a characteristic for a plurality of individuals from the customer database; determine an association between the characteristic and a fragrance from the fragrance database based on and evaluation of customer data for the plurality of individuals; store the association between the characteristic and the fragrance in an association database; and determine that the at least one characteristic is a predictor of the preference of the individual based on an assessment of the association database.

In Example 51, the subject matter of Examples 49-50 includes, instructions that, when executed by the at least one processor, cause the at least one processor to perform operations to: obtain emotional state data including at least a facial expression, a gesture, a tone of voice, a message context, or a biometric data element from the at least one sensor, camera, input device, or stream of data; and evaluate the emotional state data to determine a current emotional state of the user, wherein the characteristic is an emotional state and the preference of the user is predicted in part using the current emotional state of the user.

In Example 52, the subject matter of Examples 49-51 includes, instructions that, when executed by the at least one processor, cause the at least one processor to perform operations to: present visual stimuli associated with the at least one fragrance to the display of the user computing device; obtain an image of eyes of the user from a camera; evaluate the image to determine a vector of a gaze of the user; and determine a fragrance of interest based on the vector of the gaze, wherein the recommendation message includes an identity of the fragrance of interest.

In Example 53, the subject matter of Examples 49-52 includes, instructions that, when executed by the at least one processor, cause the at least one processor to perform operations to: obtain user provided data via an input device of the user computing device; and evaluate the user provided data using the fragrance recommendation model in conjunction with the user data.

In Example 54, the subject matter of Examples 49-53 includes, instructions that, when executed by the at least one processor, cause the at least one processor to perform operations to: present stimuli via an output device of the user computing device; obtain user biometric data from a biometric sensor; and evaluate the user biometric data to determine a physical response to the stimuli, wherein the preference is predicted in part based on the physical response.

In Example 55, the subject matter of Examples 49-54 includes, instructions that, when executed by the at least one processor, cause the at least one processor to perform operations to: obtain user personality data that includes user activity metrics and user preferences; evaluate the personality data to determine a personality type for the user; determine personality characteristics for the user based on the personality type; and add the personality characteristics to the user data.

In Example 56, the subject matter of Examples 49-55 includes, wherein the at least one characteristic includes facial features and further comprising instructions that, when executed by the at least one processor, cause the at least one processor to perform operations to: capture one or more images of a face of the user from a camera; and identify user facial features in the one or more images, wherein the preference of the user is predicted in part using the user facial features.

In Example 57, the subject matter of Examples 49-56 includes, instructions that, when executed by the at least one processor, cause the at least one processor to perform operations to: select at least one fragrance sample based on the identification of the at least one fragrance; and electronically transmit a fulfillment request to an enterprise resource planning at least one non-transitory machine-readable medium that includes a request for the at least one fragrance sample and a delivery address for the user.

In Example 58, the subject matter of Examples 49-57 includes, instructions that, when executed by the at least one processor, cause the at least one processor to perform operations to: obtain a genetic sample of the user; and sequence the genetic sample to determine an allergen profile for the user and a predicted pheromone preference for the user, wherein the preference is predicted in part using the allergen profile and the predicted pheromone preference.

In Example 59, the subject matter of Examples 49-58 includes, instructions that, when executed by the at least one processor, cause the at least one processor to perform operations to: identify a social media profile of the user; obtain social network engagement data for the user based on the social media profile; evaluate the social network engagement data to determine user characteristics for the user; and add the user characteristics to the user data.

In Example 60, the subject matter of Examples 49-59 includes, wherein the fragrance recommendation model includes an environment-fragrance chemical composition feature and further comprising instructions that, when executed by the at least one processor, cause the at least one processor to perform operations to: obtain environmental data for a proximate area of the user from an environmental sensor; and add the environmental data to the user data, wherein the preference is predicted in part based on a prediction of suitability of the at least one fragrance to the proximate area based on an evaluation of the environmental data and the chemical composition of the at least one fragrance.

In Example 61, the subject matter of Examples 49-60 includes, wherein the at least one characteristic includes user types and further comprising instructions that, when executed by the at least one processor, cause the at least one processor to perform operations to evaluate the user data to assign a user type to the user, wherein the preference is predicted in part using the user type.

In Example 62, the subject matter of Examples 49-61 includes, instructions that, when executed by the at least one processor, cause the at least one processor to perform operations to: obtain a video feed from an image sensor; process the video feed using an artificial intelligence processor to identify an emotional reaction of the user to a stimuli present in the video feed; and generate an emotive reaction attribute for the user based on the identified emotional reaction, wherein the fragrance recommendation model includes an emotive reaction feature, and wherein the preference is predicted in part using the emotive reaction attribute.

In Example 63, the subject matter of Examples 49-62 includes, wherein the at least one characteristic includes a volatile organic compound (VOC) attribute and further comprising instructions that, when executed by the at least one processor, cause the at least one processor to perform operations to: collect an air sample using a VOC sensor; evaluate the air sample to identify concentrations of a set of VOCs; query the fragrance database using the concentrations of the set of VOCs to identify a present fragrance; obtain fragrance attributes for the present fragrance from the fragrance database; and add the fragrance attribute to the user data.

In Example 64, the subject matter of Examples 49-63 includes, instructions that, when executed by the at least one processor, cause the at least one processor to perform operations to: obtain social proximity data for the user; evaluate the social proximity data to identify a connection between the user and a connection; collect connection data for the connection; extract connection characteristics from the connection data; and add the connection characteristics to the user data.

In Example 65, the subject matter of Examples 49-64 includes, wherein the at least one characteristic is a demographic parameter, a user preference parameter, or a user action parameter.

In Example 66, the subject matter of Examples 49-65 includes, wherein the fragrance recommendation model includes a fragrance ingredient-characteristic feature and further comprising instructions that, when executed by the at least one processor, cause the at least one processor to perform operations to obtain an ingredient list for the at least one fragrance, wherein the preference is predicted in part based on evaluation of the ingredient list in conjunction with the user data.

In Example 67, the subject matter of Examples 49-66 includes, wherein the at least one characteristic include at least one human parameter and at least one non-human parameter.

In Example 68, the subject matter of Examples 49-67 includes, wherein the at least one characteristic is determined to be a predictor of the preference of the individual for the at least one fragrance based on the correlation coefficient being outside a threshold.

In Example 69, the subject matter of Examples 49-68 includes, wherein the at least one characteristic is determined to be a predictor of the preference of the individual for the at least one fragrance based on the correlation coefficient for the at least one characteristic having a higher value that a second correlation coefficient for another characteristic.

In Example 70, the subject matter of Examples 49-69 includes, instructions that, when executed by the at least one processor, cause the at least one processor to perform operations to: identify an event in the user data; evaluate the user data to collect event data; extract event attributes from the event data; and evaluate the event attributes in conjunction with the user data using the fragrance recommendation model.

In Example 71, the subject matter of Examples 49-70 includes, instructions that, when executed by the at least one processor, cause the at least one processor to perform operations to: train a personality fragrance prediction model using a corpus of training data including personality traits and corresponding fragrance preferences; evaluate a fragrance attribute of a fragrance from the fragrance database using the personality fragrance prediction model to predict one or more personality traits associated with the fragrance attribute; and store the predicted one or more personality traits associated with the fragrance attribute in the fragrance database.

Example 72 is at least one machine-readable medium including instructions that, when executed by processing circuitry, cause the processing circuitry to perform operations to implement of any of Examples 1-71.

Example 73 is an apparatus comprising means to implement of any of Examples 1-71.

Example 74 is a system to implement of any of Examples 1-71.

Example 75 is a method to implement of any of Examples 1-71.

1. A method executable by computing circuitry comprising:
querying a fragrance database for at least one fragrance;
querying a customer database for a set of characteristics related to an individual;
calculating a correlation coefficient for each characteristic of the set of characteristics, the correlation coefficient representing strength of an association between the at least one fragrance and each characteristic;
selecting a parameter from an association database containing the correlation coefficient for each characteristic, the parameter selected by identifying, based on the correlation coefficient of each characteristic, wherein a characteristic of the set of characteristics is a predictor of a preference of the individual for the at least one fragrance;
creating a fragrance recommendation model using the parameter;
receiving user data from a stream of data, the user data comprising characteristic attributes of a user;
upon detection of a trigger condition, evaluating the user data using the fragrance recommendation model to predict a preference of the user for the at least one fragrance; and
transmitting a recommendation message that includes identification of the at least one fragrance to a user computing device of the user.

2. The method of claim 1, further comprising:
obtaining a characteristic for a plurality of individuals from the customer database;
determining an association between the characteristic and a fragrance from the fragrance database based on and evaluation of customer data for the plurality of individuals;
storing the association between the characteristic and the fragrance in an association database; and
determining that the characteristic is a predictor of the preference of the individual based on an assessment of the association database.

3. The method of claim 1, wherein the characteristic is a fragrance purchase history characteristic and the method further comprising:
training the fragrance recommendation model using the fragrance purchase history characteristic; and
predict the preference of the user based on a correlation coefficient for a fragrance and a purchase history characteristic attribute of the user.

4. (canceled)

5. The method of claim 1, further comprising:
obtaining user provided data via an input device of the user computing device; and
evaluating the user provided data using the fragrance recommendation model in conjunction with the user data.

6. (canceled)

7. The method of claim 1, further comprising:
obtaining user personality data that includes user activity metrics and user preferences;
evaluating the user personality data to determine a personality type for the user;
determining personality characteristics for the user based on the personality type; and
adding the personality characteristics to the user data.

8. (canceled)

9. The method of claim 1, further comprising:
selecting at least one fragrance sample based on the identification of the at least one fragrance; and
electronically transmitting a fulfillment request to an enterprise resource planning system that includes a request for the at least one fragrance sample and a delivery address for the user.

10. The method of claim 1, further comprising:
obtaining a genetic sample of the user; and
sequencing the genetic sample to determine an allergen profile for the user and a predicted pheromone preference for the user, wherein the preference is predicted in part using the allergen profile and the predicted pheromone preference.

11. The method of claim 1, further comprising:
identifying a social media profile of the user;
obtaining social network engagement data for the user based on the social media profile;
evaluating the social network engagement data to determine user characteristics for the user; and
adding the user characteristics to the user data.

12. The method of claim 1, wherein the fragrance recommendation model includes an environment-fragrance chemical composition feature and further comprising:
obtaining environmental data for a proximate area of the user from an environmental sensor; and
adding the environmental data to the user data, wherein the preference is predicted in part based on a prediction of suitability of the at least one fragrance to the proximate area based on an evaluation of the environmental data and a chemical composition of the at least one fragrance.

13. The method of claim 1, wherein the characteristic is a user type and further comprising evaluating the user data to assign a user type to the user, wherein the preference is predicted in part using the user type.

14. (canceled)

15. The method of claim 1, wherein the characteristic is a volatile organic compound (VOC) attribute and further comprising:
collecting an air sample using a VOC sensor;
evaluating the air sample to identify concentrations of a set of VOCs;
querying the fragrance database using the concentrations of the set of VOCs to identify a present fragrance;
obtaining fragrance attributes for the present fragrance from the fragrance database; and
adding the fragrance attributes to the user data.

16. The method of claim 1, further comprising:
obtaining social proximity data for the user;
evaluating the social proximity data to identify a connection between the user and a connection;
collecting connection data for the connection;
extracting connection characteristics from the connection data; and
adding the connection characteristics to the user data.

17. The method of claim 1, wherein the characteristic is a demographic parameter, a user preference parameter, or a user action parameter.

18. The method of claim 1, wherein the fragrance recommendation model includes a fragrance ingredient-characteristic feature and further comprising obtaining an ingredient list for the at least one fragrance, wherein the preference is predicted in part based on evaluation of the ingredient list in conjunction with the user data.

19. (canceled)

20. The method of claim 1, wherein the characteristic is determined to be a predictor of the preference of the individual for the at least one fragrance based on the correlation coefficient being outside a threshold.

21. The method of claim 1, wherein the characteristic is determined to be a predictor of the preference of the individual for the at least one fragrance based on the correlation coefficient for the characteristic having a higher value than a second correlation coefficient for another characteristic.

22. The method of claim 1, further comprising:
identifying an event in the user data;
evaluating the user data to collect event data;
extracting event attributes from the event data; and
evaluating the event attributes in conjunction with the user data using the fragrance recommendation model.

23. The method of claim 1, further comprising:
training a personality fragrance prediction model using a corpus of training data including personality traits and corresponding fragrance preferences;
evaluating a fragrance attribute of a fragrance from the fragrance database using the personality fragrance prediction model to predict one or more personality traits associated with the fragrance attribute; and
storing the predicted one or more personality traits associated with the fragrance attribute in the fragrance database.

24-25. (canceled)

26. A system for generating fragrance recommendations comprising:
at least one processor; and
memory comprising instructions that, when executed by the at least one processor, cause the at least one processor to perform operations to:
query a fragrance database for at least one fragrance;
query a customer database for a set of characteristics related to an individual;
calculate a correlation coefficient for each characteristic of the set of characteristics, the correlation coefficient representing strength of an association between the at least one fragrance and each characteristic;
select a parameter from an association database containing the correlation coefficient for each characteristic, the parameter selected by identifying, based on the correlation coefficient of each characteristic, a characteristic of the set of characteristics that is a predictor of a preference of the individual for the at least one fragrance;
create a fragrance recommendation model using the parameter;
receive user data for a user from a stream of data, the user data comprising characteristic attributes of the user;
upon detection of a trigger condition, evaluate the user data using the fragrance recommendation model to predict a preference of the user for the at least one fragrance; and
transmit a recommendation message that includes identification of the at least one fragrance to a user computing device of the user.

27. The system of claim 26, wherein the characteristic is a fragrance purchase history characteristic and the memory further comprising instructions that, when executed by the at least one processor, cause the at least one processor to perform operations to:
train the fragrance recommendation model using the fragrance purchase history characteristic; and
predict the preference of the user based on a correlation coefficient for a fragrance and a purchase history characteristic attribute of the user.

28. At least one non-transitory machine-readable medium comprising instructions for generating fragrance recommendations that, when executed by at least one processor, cause the at least one processor to perform operations to:
query a fragrance database for at least one fragrance;
query a customer database for a set of characteristics related to an individual;
calculate a correlation coefficient for each characteristic of the set of characteristics, the correlation coefficient representing strength of an association between the at least one fragrance and each characteristic;
select a parameter from an association database containing the correlation coefficient for each characteristic, the parameter selected by identifying, based on the correlation coefficient of each characteristic, a characteristic of the set of characteristics that is a predictor of a preference of the individual for the at least one fragrance;
create a fragrance recommendation model using the parameter;
receive user data for a user from a stream of data, the user data comprising characteristic attributes of the user;
upon detection of a trigger condition, evaluate the user data using the fragrance recommendation model to predict a preference of the user for the at least one fragrance; and
transmit a recommendation message that includes identification of the at least one fragrance to a user computing device of the user.

29. The at least one non-transitory machine-readable medium of claim 28, wherein the characteristic is a fragrance purchase history characteristic and further comprising instructions that, when executed by the at least one processor, cause the at least one processor to perform operations to:
train the fragrance recommendation model using the fragrance purchase history characteristic; and
predict the preference of the user based on a correlation coefficient for a fragrance and a purchase history characteristic attribute of the user.
